(19) United States
(12) Patent Application Publication
(10) Pub. No.: US 2025/0189962 A1
(43) Pub. Date: Jun. 12, 2025

(54) Differential Communication With Robots in a Fleet and Related Technology

(71) Applicant: Agility Robotics, Pittsburgh, PA (US)

(72) Inventors: Andrew Abate, Albany, OR (US); Daniel Alvin Bennett, Albany, OR (US); Bambi Roberts Brewer, Pittsburgh, PA (US); Ryan James Domres, Albany, OR (US); Bradley Stewart Hamner, Pittsburgh, PA (US); Sean Cambell Hunter, Philomath, OR (US); Jay David Jasper, Albany, OR (US); Brian Kirby, Pittsburgh, PA (US); Brian Lange, Tangent, OR (US); Krupal Thakolal Patel, Albany, OR (US); Alejandro Tomas Perez, Manchester, NH (US)

(21) Appl. No.: 18/504,930

(22) Filed: Nov. 8, 2023

Related U.S. Application Data
(60) Provisional application No. 63/494,666, filed on Apr. 6, 2023.

(51) Int. Cl. G05D 1/00; G05D 1/02

(52) U.S. Cl. CPC G05D 1/0055

(57) ABSTRACT

Disclosed is a method of identifying at least one deployed robot in a group of robots, differentially commanding the identified robot, and initiating a remote shutdown or disablement of at least one robot selected from a group of robots.

### CROSS-REFERENCE TO RELATED APPLICATION

This claims the benefit of U.S. Provisional Application No. 63/494,666, filed Apr. 6, 2023. The foregoing application is incorporated herein by reference in its entirety. To the extent the foregoing application and/or any other material incorporated herein by reference conflicts with the present disclosure, the preset disclosure controls.

### TECHNICAL FIELD

The present technology relates to identifying and differentially communicating with a group of robots, and even more particularly this application is drawn to a method of identifying, and initiating a shutdown of at least one robot in a group of robots, wherein in some embodiments, such a shutdown comprises a remote disablement of a the robot.

### BACKGROUND

As invention advances to match societal needs, robots, individual or groups thereof, will be deployed in a variety of roles and environments. In such roles, those environments will comprise spaces that are public, private, corporate, medical, research, transport, warehousing and many more. Additionally, robots will function: solely in the vicinity of other robots, have minimal interaction with humans, periodic interaction with humans, work alongside humans, and work directly with humans, in order to carry out a wide variety of tasks. Such roles will therefore require human-robot interactions that are both distal and proximate.

It is therefore necessary to be able to rapidly identify and communicate with an individual robot, whether that robot is a singleton, or a member of a group, in order to parse command protocols that are required to initiate and control a plethora of robot tasks. In some scenarios it may be necessary to quickly shutdown a robot, such as in an emergency situation wherein an hard shutdown is required such as de-energization of the robot, or under other circumstances it may be necessary to place the robot in a controlled cessation protocol, which is referred to herein as a soft shutdown.

What is needed therefore, are methods of rapidly identifying, selecting, and communicating with a robot, particularly in order to control a remote disablement of at least one robot within a group. In the event that the robot to be controlled is a legged robot, the type of disablement becomes even more important as a sudden full power-off shut down may impair or damage the robot.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

Disclosed herein, are methods of identifying and issuing a command to a deployed robot. In some embodiments, the method comprises: transmitting a first-signal from a device; receiving the first-signal at a target receiver located on the robot; producing a response-signal to the first-signal, wherein the response-signal is a unique robot ID; detecting the response-signal, and identifying the robot; and transmitting a second-signal from the device, wherein the second-signal commands the identified robot to perform a task. In some embodiments the robot comprises a group of robots. As used herein, a group may be defined as greater than one robot. In certain embodiments, the device is controlled by an operating entity, wherein the operating entity is one of: a human, robot, or a computer program. In other embodiments the device is a remote device. In further embodiments the remote device is: handheld, comprises personal protective equipment (PPE), is wearable, or is remotely mounted at a location distal or proximal to the robot, group or fleet thereof. In some embodiments, the medium of the first-signal and the second-signal is the same; in other embodiments, the medium of the first-signal and the second signal are different. In some embodiments the first-signal and the second-signal comprise the same datapath, and in other embodiments, the first-signal and the second signal comprise different datapaths. As used herein the term “deployed” comprises a robot being ready for, and in action, such that a robot that is stationary and ready to perform an active task is to be considered deployed.

In certain embodiments of the method of identifying and issuing a command to a deployed robot, a first-signal is: an electromagnetic signal, a 2D-code, a 3D-code, an audio signal, a thermal signal or a QR code. In some embodiments, the first-signal is an electromagnetic signal, and comprises at least one of an ionizing, visible, microwave and radio wave frequency, and in particular embodiments the electromagnetic signal is an IR signal.

In certain embodiments of the method of identifying and issuing a command to a deployed robot, the receiver is one of: a thermal sensor, an optical sensor, IR sensor, a RF sensor, a beacon, a transponder, a camera, or a QR reader. In some embodiments, the IR sensor is a photodiode, a pyroelectric sensor, or a heat sensor.

As disclosed herein, and in certain embodiments of the method of identifying and issuing a command to a deployed robot, the unique robot ID is an electromagnetic signal, and in other embodiments, the electromagnetic signal is a visible light signal, wherein, the visible light signal may be one of: a hologram, a visible pattern, a visible symbol, transmitted light of a specific frequency pattern, or a light code comprising light transmitted at a defined flash rate. In some embodiments, the visible light signal is a color coded signal, such that a color may identify a particular robot, or a color may identify a robot status. In some further embodiments, the device further comprises a laser, wherein the laser comprises a beam and is coupled to the first-signal, such that the laser is used by the operating entity to aim the first-signal at a selected robot, much like a laser pointer. In some embodiments a signal may be an RF signal, wherein, in certain embodiments the RF signal may be a low frequency RF communication with a low bandwidth.

In some other embodiments, the device comprises a sensor, wherein the sensor detects the response-signal, and compares the unique robot ID to a predetermined value, and thereby identifies the robot, in certain embodiments the sensor is one of: a photodiode, a pyroelectric sensor, a heat sensor, a RF detector, a QR reader or a camera.

In certain other embodiments of the method of identifying and issuing a command to a deployed robot, the second-signal is an electromagnetic signal, a 2D-code, a 3D-code, an audio signal, a thermal signal or a QR code, in other embodiments, the electromagnetic signal is encoded. In some embodiments, the second signal comprises the same medium as the first signal, and in other embodiments the signal comprises a different medium to the first signal.

In other embodiments disclosed herein, the task implemented is a robot shutdown, or a robot disablement. The robot shutdown is one of a soft shutdown, or a hard shutdown. In some embodiments, a hard shutdown comprises an immediate disablement of electrical power within the robot. In some embodiments an hard shutdown may result in an impairment of the robot or its payload in order to prevent impairment to a facility, or other robots for example. In some embodiments, an immediate disablement of the electrical power within a robot may be achieved by (but not limited to) at least one of: a total battery cutoff, a motor bus cutoff or a safe torque off (STO) cutoff.

In some embodiments, a time between transmitting the first-signal and initiating a hard shutdown of the robot is less than 1 second; and in other embodiments, a time between transmitting the first-signal and initiating a hard shutdown of the robot is less than 0.10 seconds. In some embodiments, the hard shutdown is implemented by triggering a fuse, wherein the fuse is one of a MOSFET, explosive or busbar fuse, in other embodiments, the triggering is by a high voltage Electrostatic discharge (ESD touch) or by a directed electromagnetic signal.

In further embodiments, the task is a soft shutdown, wherein the soft shutdown initiates a power down of the robot or places the robot in cessation, and a time between transmitting the first-signal and initiating the soft shutting down of the robot is in some embodiments less than 1 second.

In some embodiments, the response-signal is a visible signal and the detecting is by a human operating entity.

In other embodiments, the receiver comprises a visible response element, and wherein the visible response element is activated by the first-signal, and wherein the visible response element transmits an active light code. In some embodiments the visible response element is a photodiode. In further embodiments, the active light code is emitted at a predefined flash rate, wherein the active light code is a unique robot ID, and in some embodiments the robot ID is visible to an operating entity. In other embodiments, The robot ID is visible to an operating entity without the use of a device. In other embodiments, the active light code emitted is indicative of a defined state of the robot, wherein the defined robot state is one of: on, stalled, off-line, undergone a soft shutdown or has undergone a hard shutdown. In some embodiments, a robot that has undergone a soft shutdown is still intact and operable. In other embodiments, a robot that has undergone a hard shutdown may not be operable, due to impairment, or a fused or incomplete circuitry for example. In certain embodiments, the device may transmit a command in the form of a signal in response to the defined robot state, and place the robot in a further state as selected by the operating entity.

Other embodiments disclosed herein are drawn to a method of initiating a remote disablement of at least one deployed robot of a group of deployed robots, wherein the method comprises: transmitting a first-signal from a remote device to each robot; receiving the first-signal at a target receiver located on each of the robots comprising the group; processing the first-signal at the receiver located on each robot, performing a robot status evaluation at each robot in response to the first-signal; and performing a disablement if a predetermined status evaluation criteria is not met. In other embodiments, if a predetermined status evaluation criteria is met, an operating entity may choose to command a robot to perform a number of tasks by virtue of the remote device. A status evaluation may for example comprise a heartbeat or watchdog process, or may comprise comparing a generated data signal, and performing a data signal match, if a match occurs a required condition is met, or if the match does not occur then a required condition is not met and the robot initiates a shutdown or disablement. In some embodiments of initiating a remote disablement of at least one deployed robot of a group of deployed robots, the receiver is visibly located on the robot. In other embodiments, the signal is an electromagnetic signal, comprising at least one of an ionizing, visible, microwave and radio wave frequency, and in further embodiments, the signal is an encoded IR signal. In certain embodiments the device is handheld, is wearable, comprises personal protective equipment (PPE), or is remotely mounted at a location distal or proximal to the deployed robot. In some embodiments the wearable remote device may comprise a glove. In other embodiments, the remote device may further comprise a visible light source, such as a laser diode which transmits a laser beam, and wherein the laser beam is coupled to the encoded IR signal, such that the operating entity aims the laser beam at a selected robot and visually identifies the robot to be targeted by the coupled encoded IR signal, much like a laser pointer. In certain embodiments, the remote disablement of the robot is by one of: a soft shutdown, or a hard shutdown, wherein the hard shutdown is implemented by triggering a fuse, wherein the fuse is one of a MOSFET, explosive or busbar fuse. In such embodiments, the fuse may be triggered by a high voltage ESD touch, or by a directed electromagnetic signal. One or more of these methods may be particularly effective with respect to legged robots.

In certain other embodiments, a method of initiating a remote disablement of at least one deployed robot selected from a group of robots is disclosed. Such a method comprises transmitting a first-signal from a remote device which is controlled by an operating entity; receiving the first-signal at a target receiver located on each robot of the group; producing and transmitting a response-signal, in response to the first-signal, such that the response-signal is a unique robot ID. The unique response-signal is received at a sensor located on the remote device, and compared to a predetermined value in order to identify the robot. A second-signal is produced at the remote device in response to each response-signal, and each second-signal is transmitted to only the robots that do not transmit a response-signal, such that the second-signal initiates a disablement of each robot that did not transmit a response-signal. In such embodiments, the robots which respond to the first signal, provide a response signal comprising a robot ID, these robot IDs are parsed and compared for example to a pre-constructed library of IDs, such that the non-responding robots are further identifiable. In certain embodiments the first-signal also directs the robot to produce a response-signal comprising a robot ID which is transmitted to the remote device, such that the robot is identified, the first-signal also initiates a robot status evaluation protocol. In certain embodiments, the first-signal may be encoded to command both tasks. In further embodiments, the operating entity is one of: a human, robot, or a computer program. In still other embodiments, the remote device is handheld, comprises personal protective equipment (PPE), is wearable, or is remotely mounted at a location distal or proximal to the robot.

In certain embodiments of the method of initiating a remote disablement of at least one deployed robot selected from a group of robots, the first-signal is one of an electromagnetic signal, an electrical signal, a 2D code, a 3D code, a barcode, a QR code, a heat signal or an audio-signal, when the signal is an electromagnetic signal it comprises at least one of an ionizing, visible, microwave and radio wave frequency, and in further embodiments the electromagnetic signal is an IR signal. In some embodiments of the method, the receiver is one of a light sensor, IR sensor, a RF sensor, transponder, a beacon, a QR code reader, or a camera, or thermal sensor; in certain embodiments, the receiver is an IR sensor, wherein the IR sensor is a photodiode, a pyroelectric sensor, or a heat sensor. In other embodiments, the response signal which comprises a unique robot ID, is a visible light signal, and the detecting of the response-signal is by a human operating entity. In other embodiments the visible signal may be detected by a device. The visible light signal is at least one of: a color coded signal, a hologram, a visible pattern, a visible symbol, a visible light transmitted at a specific frequency pattern, or a light code comprising light transmitted at a defined flash rate (in Hz or flashes per second, or pulsed light with a defined pulsed duration). Thus, in some embodiments a response-signal, comprising a unique robot ID is an electromagnetic encoded signal, which in some embodiments is a visible light signal.

In certain embodiments of the method of initiating a remote disablement of at least one deployed robot selected from a group of robots, the device further comprises a visible light source, wherein the visible light source is a laser, the laser comprises a beam and the beam is coupled to the first-signal, wherein the laser beam is used by the operating entity to aim the first-signal at a selected robot, thereby providing visible confirmation that the correct robot is selected for communication and in some embodiments selected for disablement. In other embodiments, the device further comprises a sensor, wherein the sensor detects the response-signal, and compares the unique robot ID to a predetermined value, and identifies the robot. In certain embodiments the sensor located on the device (which may in certain circumstances be differentiated as the device-sensor) is a photodiode, a pyroelectric sensor, a heat sensor, a RF detector, or a camera. In other embodiments, the second-signal is an electromagnetic signal, a 2D-code, a 3D-code, or an acoustic signal, in further embodiments the electromagnetic signal may be thermal, the 2D-code may be a QR-code, and an acoustic signal may be an audio signal, and in still further embodiments the electromagnetic signal is encoded.

In certain embodiments of the method of initiating a remote disablement of at least one deployed robot selected from a group of robots, the remote disablement is a hard shutdown. In certain embodiments a time between transmitting the first-signal and initiating shutting down of the robot is less than 1 second. In some embodiments, a time between transmitting the first-signal and initiating a hard shutting down of the robot is between 0.1 and 0.5 seconds. In some embodiments, a hard shutdown is by activating a robot fuse, or by an electrostatic discharge, wherein the fuse is one of MOSFET, a busbar or an explosive fuse. In other embodiments, wherein the remote disablement is a soft shutdown that initiates a power down of the robot or places the robot in cessation, the time between transmitting the first-signal and initiating shutting down of the robot may be less than 1 second, between 1 and 10 seconds, or greater than 10 seconds, such that completion of a soft shutdown occurs more slowly than a hard shutdown, therein completion of a soft shutdown occurs in some embodiments in greater than 0.5 seconds from the transmitting of a first signal.

In other embodiments, methods of initiating a remote disablement of a deployed robot are disclosed. Such methods include transmitting a signal from a remote device and receiving the signal at a target receiver located on the robot, wherein the receiver processes the signal and the robot performs a shutdown. In some embodiments, the device is operated by an operating entity, such as a human, a robot, or a computer program on an individual computer, or a computer program on a network. In further embodiments, the device comprises a screen, such that the screen displays a QR code. The receiver, located on the robot is, in some embodiments a QR code reader, or a camera and the receiver processes the QR code. In further embodiments, the QR code comprises a command that implements a robot shutdown, or disablement, whilst in still further embodiments the QR code may comprise any predetermined code or command that may be required and then selected by the operative entity.

Disclosed herein, in certain embodiments, is a method of identifying and issuing a command to a deployed robot, the method comprises scanning a code with a device, wherein the code is visibly located on a robot, and wherein the code comprises a unique robot ID, then comparing the robot ID to a predetermined value and identifying the robot, and transmitting a signal from the device, such that the signal commands the identified robot to perform a task. In some embodiments, the code is a QR code, and in other embodiments the device is a QR code reader, or a camera. In further embodiments, the task is a remote disablement.

In some other embodiments of the methods described herein, a remote device may further comprise a receiver; and in certain other embodiments of the methods the robot comprises a transmitter. In some embodiments, the device and the robot are bidirectional transmitters and receivers. Thus, in some embodiments, the signal received by the remote device and the signal transmitted by the receiver located on the robot are at least one of a QR code, an electromagnetic signal, an electric signal, an audio signal, or a thermal signal. In some embodiments, a robot may comprise a transponder, and a remote device may comprise a further transponder, wherein each transponder may emit, and receive signals, wherein the data received may be both static and dynamic. In other embodiments, transponders located on individual robots may be used to additionally provide location data, such that an operative entity or another robot of the group may be able to calculate the distance between a robot that is necessitating shutdown to other proximal robots. In further embodiments, any method of implementing a disablement of a deployed robot as described herein, may be a primary safety measure, a redundancy safety measure, or comprise a hierarchical protocol of safety measures that are implemented in response to a situation as predefined, wherein for example, a robot will initiate a soft or hard shutdown based on whether the appropriate precoded conditions are met, or in other embodiments as dynamically determined in real-time.

In certain embodiments a method of identifying and issuing a command to at least one deployed robot is disclosed, wherein the method comprises identifying at least one robot that requires commanding to perform a task; and communicating with and initiating a command to at least one robot to perform the task, wherein the robot performs the task. In some embodiments, identifying the at least one robot comprises transmitting a first-signal from a device; receiving the first-signal at a target receiver located on the robot and producing a response-signal to the first-signal, wherein the response-signal is a unique robot ID; detecting the response-signal; and identifying the robot. In other embodiments, communicating with and initiating a command to the at least one robot comprises transmitting a second-signal from the device, wherein the second-signal commands the identified robot to perform the task. In certain embodiments the device is controlled by an operating entity, wherein the operating entity is one of: a human, robot, or a computer program. In other embodiments the device is a remote device, and the remote device may be handheld, comprises personal protective equipment (PPE), is wearable, comprises a glove, comprises a haptic feedback system, or is remotely mounted at a location distal or proximal to the robot. In some embodiments, the first-signal is an electromagnetic signal, a 2D-code, a 3D-code, an acoustic signal, a thermal signal or a QR code; and in other embodiments wherein the first-signal is an electromagnetic signal, it comprises at least one of an ionizing, visible, microwave and radio wave frequency, in further embodiments the electromagnetic signal is an IR signal. In certain embodiments, the receiver is one of a thermal sensor, an optical sensor, IR sensor, a RF sensor, a beacon, a transponder, a microphone, a camera, or a QR reader; in other embodiments the receiver is an an IR sensor, and may be a photodiode, a pyroelectric sensor, or a heat sensor. In certain embodiments the response-signal comprising a unique robot ID is an electromagnetic signal, wherein the electromagnetic signal is a visible light signal, wherein the visible light signal is color coded, a hologram, a visible pattern, a visible symbol, transmitted light of a specific frequency pattern, or a light code comprising light transmitted at a defined flash rate. In some further embodiments, the response-signal is a visible signal and detecting is by a human operating entity.

In some embodiments the device further comprises a laser, and in other embodiments the laser comprises a beam and is coupled to the first-signal, wherein the laser is used by the operating entity to aim the first-signal at a selected robot. In further embodiments the device comprises a sensor, wherein the sensor detects the response-signal, and compares the unique robot ID to a predetermined value, and identifies the robot. In some embodiments the sensor is a photodiode, a pyroelectric sensor, a heat sensor, a RF detector, or a camera. In certain embodiments the second-signal is an electromagnetic signal, a 2D-code, a 3D-code, an acoustic signal, a thermal signal or a QR code, and in other embodiments, the electromagnetic signal is encoded. In some preferred embodiments of the method of identifying and issuing a command to at least one deployed robot, the task with which the robot is commanded to perform is a robot shutdown, or a robot disablement. In some embodiments the robot shutdown is a hard shutdown, in some embodiments the hard shutdown requires an immediate removal of power to the robot actuators, wherein the hard shutdown is implemented by removing the power needed to generate a torque or force in an electrical motor, using the safe torque off (STO) function of the power drive system, or by triggering a fuse, wherein the fuse is one of a MOSFET, explosive or a busbar fuse, and wherein triggering is by a high voltage electrostatic discharge, or by a directed electromagnetic signal. In certain other embodiments, a task is a soft shutdown; and in some embodiments the soft shutdown initiates a deceleration of robot movement, and powering down of the robot. In some embodiments disclosed herein, the target receiver located on at least one robot comprises a visible response element, and the visible response element is a laser which is activated by the first-signal, wherein the laser emits an active light code, and the active light code is emitted at a predefined flash rate. In some embodiments the active light code emitted is a unique robot ID, wherein the robot ID is identifiable to an operating entity. In further embodiment, the active light code emitted is indicative of a defined robot state, wherein the defined robot state is one of: on, stalled, off-line, undergone a soft shutdown or undergone a hard shutdown, such as but not limited to, a particular color, flash rate or pulse being indicative of a state, and in still further embodiments the device transmits a command signal in response to the active light code, and wherein the command is a remote disablement.

In certain other embodiments of the method of identifying and issuing a command to at least one deployed robot, the robot comprises a group of robots, wherein the method comprises identifying at least one robot that requires commanding to perform a task; and communicating with and initiating a command to at least one robot to perform the task, wherein the robot performs the task. In some embodiments, identifying comprises transmitting a first-signal from a remote device to each robot; receiving the first-signal at a target receiver located on each of the robots; processing the first-signal at the receiver located on each robot, and producing a response-signal to the first-signal, wherein the response-signal is a unique robot ID and identifies the robot; and communicating with and initiating a command to the at least one robot further comprises transmitting a second-signal from the device, wherein the second-signal commands the identified robot to perform a task, wherein the task is a remote shutdown.

Disclosed herein in certain preferred embodiments, is a method of identifying and initiating a remote disablement of at least one deployed robot of a group of robots, wherein the method comprises; identifying each robot comprising the group of robots; and communicating with at least one robot and initiating a remote disablement of at least one robot of a group of robots. In some embodiments, identifying at least one robot comprises: transmitting a first-signal from a remote device to each robot; receiving the first-signal at a target receiver located on each of the robots comprising the group; processing the first-signal at the receiver located on each robot, and producing a response-signal to the first-signal, wherein the response-signal is a unique robot ID and identifies the robot; and communicating with and initiating a remote shutdown of at least one robot of a group of robots comprises performing a robot status evaluation at each robot that received the first-signal; and performing a disablement of the robot if a predetermined status evaluation criteria is not met. In some further embodiments, the receiver is visibly located on the robot; in other embodiments, the first signal is an electromagnetic signal, comprising at least one of an ionizing, visible, acoustic, microwave, or radio wave frequency, and wherein in certain embodiments the signal is an encoded IR signal. In further embodiments the device is handheld, is wearable, comprises personal protective equipment (PPE), or is remotely mounted at a location distal or proximal to the deployed robot; in other embodiments the device further comprises a visible light source, wherein the visible light source is a laser diode which transmits a laser beam, and wherein the laser beam is coupled to the encoded IR signal, and wherein the operating entity aims the laser beam at a selected robot and visually identifies the robot to be targeted by the coupled encoded IR signal. In certain embodiments, a robot status evaluation comprises maintaining a heartbeat signal, or a watchdog signal; or a data signal match. In further embodiments, the disablement comprises one of a soft shutdown or a hard shutdown, wherein a hard shutdown is implemented by triggering a fuse and wherein the fuse is one of a MOSFET, explosive or busbar fuse; and wherein the fuse is triggered by a high voltage ESD touch, or by a directed electromagnetic signal.

In another preferred embodiment, a method of identifying and initiating a remote disablement of at least one deployed robot of a group of robots is disclosed, wherein the method comprises; identifying each robot comprising the group of robots; and communicating with at least one robot and initiating a remote disablement of at least one robot of a group of robots. In some embodiments; wherein the identifying at least one deployed robot selected from a group of robots comprises: transmitting a first-signal from a device, wherein the device is remote and controlled by an operating entity; receiving the first-signal at a target receiver located on each robot of the group; producing and transmitting a response-signal to the first-signal, wherein the response-signal comprises a unique robot ID; and detecting the response-signal at a sensor located on the remote device, and comparing to a predetermined value and identifying the robot; and wherein communicating with each robot and initiating a remote disablement of at least one robot of a group of robots comprises: producing a second-signal at the device in response to each response-signal, wherein the second-signal is transmitted to each robot that does not transmit a response-signal, wherein the second-signal initiates a remote disablement of each robot that did not transmit a response-signal. In some embodiments the operating entity is one of a human, robot, or a computer program; in some further embodiments the remote device is handheld, comprises personal protective equipment (PPE), is wearable, comprises a haptic feedback system, or is remotely mounted at a location distal or proximal to the robot. In certain embodiments the first-signal is an electromagnetic signal, a 2D code, a 3D code, a barcode, a QR code, a heat signal or an acoustic-signal, wherein the electromagnetic signal comprises at least one of an ionizing, visible, microwave and radio wave frequency; and wherein the electromagnetic signal is an IR signal. In some embodiments the receiver is one of a light sensor, IR sensor, a RF sensor, a beacon, a transponder, a QR code reader, or a camera, or thermal sensor; and in a further embodiment the IR sensor is a photodiode, a pyroelectric sensor, or a heat sensor. In certain embodiments the unique robot ID comprises a visible light signal, wherein the visible light signal is color coded, a hologram, a visible pattern, a visible symbol, transmitted light of a specific frequency pattern, or a light code comprising light transmitted at a defined flash rate; and in other embodiments the unique robot ID is an electromagnetic encoded signal. In certain embodiments, the device further comprises a visible light source, wherein the visible light source is a laser; wherein the laser comprises a beam and is coupled to the first-signal, and wherein the laser is used by the operating entity to aim the first-signal at a selected robot. In some embodiments the device comprises a sensor, wherein the sensor detects the response-signal, and compares the unique robot ID to a predetermined value, and identifies the robot; and in further embodiments the sensor is a photodiode, a pyroelectric sensor, a heat sensor, a microphone, a RF detector, a QR reader or a camera. In other embodiments the second-signal is an electromagnetic signal, an electrical signal, a 2D-code, a 3D-code, an acoustic signal, a thermal signal or a QR code; and in a further embodiment the electromagnetic signal is encoded. In some embodiments the remote disablement is one of a soft shutdown or a hard shutdown. In further embodiments a hard shutdown is by triggering a fuse, or by an electrostatic discharge and wherein the fuse is one of MOSFET, a busbar or an explosive fuse; and a soft shutdown initiates a deceleration of robot movement, and a power down of the robot or places the robot in cessation. In certain embodiments, the response-signal is a visible signal and wherein detecting is by a human operating entity.

In a certain preferred embodiment, a method of identifying and initiating a remote disablement of at least one deployed robot of a group of robots is disclosed, wherein the method comprises identifying each robot comprising the group of robots; and communicating with at least one robot and initiating a remote disablement of at least one robot of a group of robots. In some embodiments identifying each robot comprises an operative entity visually identifying each robot, and selecting at least one robot requiring disablement. In further embodiments, communicating with each robot and initiating a remote disablement of at least one robot of a group of robots comprises: transmitting a signal from a remote device; and receiving the signal at a target receiver located on the robot, wherein the receiver processes the signal and the robot performs a shutdown. In some embodiments, the device is operated by an operating entity, and wherein the operating entity is a human, a robot, or a computer program on an individual computer, or a computer program on a network; wherein the device comprises a screen, and wherein the screen displays a QR code. In some embodiments, the receiver located on the robot is a QR code reader, or a camera; wherein the QR code reader, or a camera. receiver scans and processes the QR code and performs a shutdown.

In certain other embodiments, a method of identifying and initiating a remote disablement of at least one deployed robot of a group of robots is disclosed, wherein the method comprises Identifying each robot comprising the group of robots; and communicating with at least one robot and initiating a remote disablement of at least one robot of a group of robots. In some embodiments, identifying at least one deployed robot comprises scanning a code with a device, wherein the code is visibly located on a robot, and wherein the code comprises a unique robot ID, and comparing the robot ID to a predetermined value and identifying the robot; and wherein communicating with each robot and initiating a remote disablement of the at least one robot of a group of robots, comprises transmitting a signal from the device, wherein the signal commands the identified robot to perform a remote shutdown. In further embodiments the code is a LCD code or QR code; and the device is a QR code reader, or a camera. In some embodiments of communicating with each robot and initiating a remote disablement of at least one robot of a group of robots comprises transmitting a short range signal from a remote device, wherein the remote device is in proximity to the at least one robot requiring disablement; and receiving the signal at a target receiver located on the robot, wherein the receiver processes the signal and the robot performs a shutdown. In some embodiments, proximity is over a range of less than 10 meters, less than 5 meters, or less than 1 meter from the robot requiring disablement. In some embodiments, the short range signal is an electromagnetic signal, and wherein the signal is tunable; and in other embodiments the short range signal comprises an electrostatic discharge, an RF signal, or an IR signal. In other embodiments, the remote device comprises an extendable object such that the length or reach of the object may be increased, a stick, a pole, a haptic feedback system, or a drone.

In some embodiments, identifying each robot comprises an operative entity visually identifying each robot, and selecting at least one robot requiring disablement, and wherein communicating with each robot and initiating a remote disablement of at least one robot of a group of robots comprises: activating a remote device; transmitting a signal from a remote device; and receiving the signal at a target receiver located on the robot, wherein the receiver processes the signal and wherein each robot of the group that receives the signal performs a remote disablement. In some embodiments, the remote device is activated by manually completing an electrical circuit, and wherein the remote device comprises an emergency activated RF signal wherein the device emits a sound-wave signal, and wherein the signal is tunable. In further embodiments, the receiver located on the robot comprises a microphone, wherein the receiver converts the sound-wave to an electrical signal which comprises a shutdown command and wherein each robot of the group that receives the signal executes a robot disablement.

In some further embodiments, identifying each robot comprises an operative entity visually identifying each robot, and selecting at least one robot requiring disablement, and wherein communicating with each robot and initiating a remote disablement of at least one robot of a group of robots comprises: transmitting a signal from a RFID reader, wherein the reader is in proximity to the at least one robot requiring disablement; and receiving the signal at a RFID tag, wherein the RFID tag processes the signal and the robot performs a shutdown. In some embodiments the RFID reader is located on each robot, and a RFID tag is located on a device; and in other embodiments, the RFID reader is located on the device, and the RFID tag is located on each robot. In some embodiments the RFID reader or the RFID tag comprises a projectile, wherein an operative entity places the projectile in proximity to the at least one robot requiring disablement.

In some embodiments disclosed herein, the remote device is a wearable device comprising a sensor, and wherein the sensor captures three dimensional coordinate data that is a command gesture which may be generated by an operating entity, and transmits a signal comprising the coordinate data, to the receiver located on the robot, wherein the receiver processes the signal and the robot performs a shutdown, and in further embodiments the command gesture is a visible signal, such as a hand gesture comprising a stop signal, or a directional signal. In some embodiments the device comprises a gyroscope and an accelerometer, and in other embodiments the device comprises a haptic feedback system.

In certain embodiments of communicating with each robot and initiating a remote disablement of at least one robot of a group of robots comprises the at least one robot scanning a 3D object, processing the geometry of the object into a data-signal, matching the data-signal to a condition value; and the robot performing a shutdown. In some embodiments the 3D object is a human face, and wherein the geometry of the object comprises a facial expression, and wherein the facial expression data signal matches a condition value that triggers a robot shutdown.

Another embodiment of communicating with at least one robot and initiating a remote disablement of at least one robot of a group of robots, comprises manually opening a circuit comprising the robot or activating a switch and disabling the robot, wherein manually opening the circuit or activating the switch comprises pulling and removing at least one visible flag or tag positioned on the robot, such that the circuit is broken.

A further embodiment of communicating with each robot and initiating a remote disablement of at least one robot of a group of robots comprises: transmitting a signal from a remote device; and receiving the signal at a target receiver located on the robot, wherein the receiver processes the signal and executes a hierarchical command protocol, wherein the robot initiates a self evaluation protocol, and wherein a predefined condition value is met, the robot initiates an soft shutdown, and wherein the predefined condition value is not met a hard shutdown is initiated. In a certain embodiment, communicating with each robot and initiating a remote disablement of at least one robot of a group of robots comprises: transmitting a second signal from the remote device; and receiving the second signal at a target receiver located on the robot, wherein the receiver processes the second signal and executes a hierarchical command protocol, wherein the robot initiates a self evaluation protocol, and wherein a predefined condition value is met, the robot initiates an soft shutdown, and wherein the predefined condition value is not met a hard shutdown is initiated.

In one embodiment, a method of identifying a subset of a group of deployed legged robots for purposes of communicating instructions to only the subset, is disclosed herein, wherein the method comprises: transmitting a first-signal to the group of deployed legged robots; receiving and processing the first-signal at the group; transmitting a response-signal from each legged robot of the group; detecting the response-signal; and determining the identity of each legged robot that belongs to the subset. In some embodiments, transmitting the first-signal is by a first device and wherein the first device is one of a remote device and a fleet management system. In another embodiment, the response-signal comprises at least one of a unique robot ID and a robot status identifier. In a further embodiment, the unique robot ID is used to determine the identity of each legged robot that belongs in the subset, and in a still further embodiment, each robot of the subset receives a further communication based on its robot status identifier. In another embodiment, the further communication is a safety-related instruction, and in a still further embodiment the safety-related instruction comprises a command to perform a remote shutdown. In some embodiments, the remote shutdown comprises a hard shutdown, wherein electrical power to the robot is immediately discontinued. In other embodiments, the remote shutdown is a soft shutdown, wherein the robot is brought to a safe limited position, and then electrically powered off, wherein the safe limited position is one of a standing position, a crouching position, a squatting position, a sitting position, and a controlled collapsed position, such that in some embodiments the robot is in a dynamically stable position. In a further embodiment, the group of legged robots further comprises a second-subset of legged robots that do not return a response-signal. In a still further embodiment, the method further comprises identifying the non-responsive robots and sending them a command to perform a remote shutdown.

In some embodiments, a method of identifying a subset of a group of deployed legged robots for purposes of communicating safety-related instructions to only the subset, wherein the method comprises: receiving a notification of a safety-related issue requiring communication with the subset; transmitting a first-signal to a first location; receiving and processing the first-signal at the subset of legged robots; transmitting a response-signal from each legged robot of the subset; detecting the response-signal; confirming the identity of each legged robot of the subset; and communicating a safety-related instruction to the first subset. In a further embodiment, the first location is at least one of: a work zone, an unauthorized work zone, a zone in proximity to a human, a zone in proximity to a legged robot, a zone in proximity to a number of robots, a zone in proximity to a danger, a zone in proximity to a payload, a zone comprising a work cell, a zone in proximity to a charging station, a zone in proximity to an object, a zone in proximity to an environmental danger, and a zone in proximity a maintenance area; and in a still further embodiment the safety-related instructions comprise an instruction to perform a remote shutdown, wherein the remote shutdown is one of a hard shutdown and a soft shutdown.

In another embodiment, a system for identifying specific deployed legged robots from a group of deployed legged robots for purposes of diagnosing a robot operative state, is disclosed, wherein the method comprises: transmitting a first-signal to each of the legged robots of the group; receiving and processing the first-signal at each of the legged robots, and transmitting a response-signal from each legged robot; detecting the response-signal, wherein the response signal comprises a unique legged robot ID and a robot status identifier; identifying each legged robot; and assigning a robot operative state to each identified legged robot, wherein each identified legged robot is ready to receive a further communication based on the legged robot operative state. In one embodiment, the robot status identifier indicates that the robot is fully operative, sub-operative, requiring maintenance, requiring charging, requiring relocation, requiring a soft shutdown, requiring a hard shutdown, or requiring activation. In a further embodiment, the group comprises all legged robots at a first location, wherein the first location is a first zone, and wherein the first zone comprises the range of the first-signal, and wherein the range of the signal is modifiable in order to change the size of the first zone.

In another embodiment, a computing system operably associated with a group of deployed legged robots, is disclosed, wherein the computing system comprises: a data processing hardware; and memory hardware in communication with the data processing hardware, the memory hardware storing instructions that when executed on the data processing hardware cause the data processing hardware to perform operations comprising claim 1, and wherein the system is further operably associated with a remote device, a fleet management system, a warehouse control system, or a work cell system in order to communicate an instruction to the group of deployed legged robots. In a further embodiment, the instruction communicated is a hard shutdown or a soft shutdown of at least one robot of the group of deployed legged robots.

Further, in any of the embodiments disclosed herein, the remote device may comprise a receiver, similarly, in any of the embodiments disclosed herein, the receiver located on the robot may further comprises a transmitter, such that if the remote device further comprises a receiver; and the receiver located on the robot further comprises a transmitter, then device and the robot are bidirectional transmitters and receivers; in further embodiments the signal received by the remote device and the signal transmitted by the receiver located on the robot are at least one of a QR code, an electromagnetic signal, an electric signal, an acoustic signal, or a thermal signal. As will be apparent to one of ordinary skill in the art, any embodiment of the methods disclosed herein may be combined with any further non-conflicting method or combination thereof.

Disclosed herein in, some other embodiments, are methods of directing a group of deployed autonomous robots to place themselves in a safe-state, wherein a method comprises determining, based on one or more identified conditions, a safety-related action each of the robots in the group should undertake; transmitting one or more signals to each of the robots in the group; whereby the one or more signals cause each of the robots in the group to place themselves in a safe-state. In some embodiments it may be required to place a robot in a safe state if the robot is displaying unauthorized behaviors. In some embodiments an unauthorized behavior comprises a behavior which is not defined by a workcell protocol, FMS protocol, a predefined robot software protocol, a robot user protocol, or other such behaviors such as entering a restricted area or being in close proximity to a human, robot, an object or a situation that is suboptimal to robot function. In certain embodiments the group comprises one or more bipedal robots. In some embodiments, the one or more signals comprises a signal having a first range, wherein the signal is transmitted by a device, and wherein the device is one of a fleet management system, a warehouse control system, a work cell system, and a remote device. In a further embodiment, a device as described herein comprises at least one processor. In certain embodiments the signal is transmitted from a remote device, and wherein the remote device is located within the first range. In one embodiment a remotely operated vehicle carries the remote device to a location within the first range, and in a further embodiment the remote device comprises a RFID object, such as a ball that is moved to a location within the first range. In other embodiments the range of the signal is modifiable, and in a further embodiment the range of the signal is fixed. In certain further embodiments, transmitting the signal comprises activating the remote device by completing a circuit of the remote device. In certain embodiments an identified condition comprises requiring maintenance, requiring charging, requiring relocating from a first location to a second location, requiring shutdown, requiring switching task, and requiring activation. In other embodiments, the safety-related action is one of a category one shutdown and a category zero shutdown.

In further embodiments, the step of transmitting one or more signals comprises scanning an object to obtain an object representation by the group of robots; and interpreting, by the group of robots, that the object representation correlates to a command to move to a safe-state. In still further embodiments, the step of transmitting one or more signals comprises: generating an acoustic signal; receiving the signal at the subset of robots; and correlating, by the group of robots, the acoustic signal to a command to move to a safe-state. The acoustic signal is one or more of a voice command and a whistle.

In certain other embodiments, the step of transmitting one or more signals comprises configuring the deployed robot to move to a safe-state in the event a safety circuit is opened; and opening the safety circuit on the robot. In further embodiments, the step of opening a safety circuit on the robot comprises removing a flag from the robot.

In some embodiments, the method of directing a group of deployed autonomous robots to place themselves in a safe-state further comprises executing, by each of the robots in the group, a hierarchical command protocol after receiving the one or more signals, wherein each of the robots in the group initiates a self evaluation protocol, wherein if a predefined condition value is met, the robot initiates a soft shutdown, and the protocol places the group of robots in a safe-state.

In certain embodiments, a computing system operably associated with a group of robots is disclosed, wherein the computing system comprises data processing hardware; and memory hardware in communication with the data processing hardware, the memory hardware storing instructions that when executed on the data processing hardware cause the data processing hardware to perform operations comprising methods of directing the group of robots to place themselves in a safe-state In other embodiments, a safe state comprises a robot that is powered down, in a safe limited position, or in a stand-by mode.

In a further embodiment, method of directing a group of one or more deployed bipedal robots to perform a remote shutdown in response to an identified safety related condition is disclosed, wherein the method comprises: determining, that each robot in the group requires a safety related shutdown, wherein the safety-related shutdown is one of a category one shutdown and a category zero shutdown; transmitting at a processor, one or more signals to each of the robots in the group, wherein the one or more signals comprise a signal having a range which is one of modifiable and fixed; and executing, by each of the robots in the group, a hierarchical command protocol after receiving the one or more signals, wherein each of the robots in the group initiates a self evaluation protocol, wherein if a predefined condition value is met the robot initiates a category one shutdown and the protocol places each of the robots in the group in a safe-state and wherein each robot is powered down, and if the predefined condition value is not met the robot initiates a category zero shutdown, and power to its motors are immediately cut.

These and other features and advantages will be apparent from a reading of the following detailed description and a review of the appended drawings. It is to be understood that the foregoing summary, the following detailed description and the appended drawings are explanatory only and are not restrictive of various aspects as represented in the claims disclosed herein or as claimed.

### BRIEF DESCRIPTION OF THE DRAWINGS

The accompanying drawings, which are incorporated in and form a part of the specification, illustrate the embodiments of the invention and, together with the written description, serve to explain the principles, characteristics, and features of the invention.

FIGS. 1-3 are, respectively, a first perspective view, a second perspective view, and a front profile view of a bipedal (legged) robot in accordance with at least some embodiments of the present invention with the robot being in a first state.

FIG. 4A is a block diagram illustrating an electrical and computer system of the robot shown in FIGS. 1-3, and FIG. 4B is a block diagram illustrating selected portions of a software architecture of the robot shown in FIGS. 1-3.

FIG. 5A-5D illustrate a method(s) of identifying and commanding a robot in accordance with at least some embodiments of the presently disclosed technology.

FIGS. 6-8 are flowcharts corresponding to methods for identifying a legged robot in accordance with at least some embodiments of the present invention, and in some embodiments initiating a remote disablement or shutdown of at least one legged robot comprising a group of robots. In other embodiments, the robots described herein are non-legged robots.

While implementation of the disclosed inventions are described herein by way of example, those skilled in the art will recognize that they are not limited to the embodiments or drawings described. It should be understood that the drawings and detailed description thereto are not intended to limit implementations to the particular form disclosed, but on the contrary, the intention is to cover all modifications, equivalents, and alternatives falling within the spirit and scope as defined by the appended claims. It should also be understood that the term “about” when used in conjunction with a percentage or other numerical amount, means plus or minus 10% of that percentage or other numerical amount. For example, the term “about 80%” would encompass 80% plus or minus 8%. The headings used herein are not meant to be used to limit the scope of the description claims or claims.

### DETAILED DESCRIPTION

The following detailed description includes the best currently contemplated modes of carrying out exemplary embodiments of the invention. The description is not to be taken in a limiting sense, but is made merely for the purpose of illustrating the general principles of the invention, and in the following description, for purposes of explanation, numerous specific details are set forth in order to provide a thorough understanding of example embodiments. It will be evident to one skilled in the art, however, that embodiments can be practiced without these specific details. In some instances, well-known methods or components have not been described in detail so that the details of the present invention are not obfuscated.

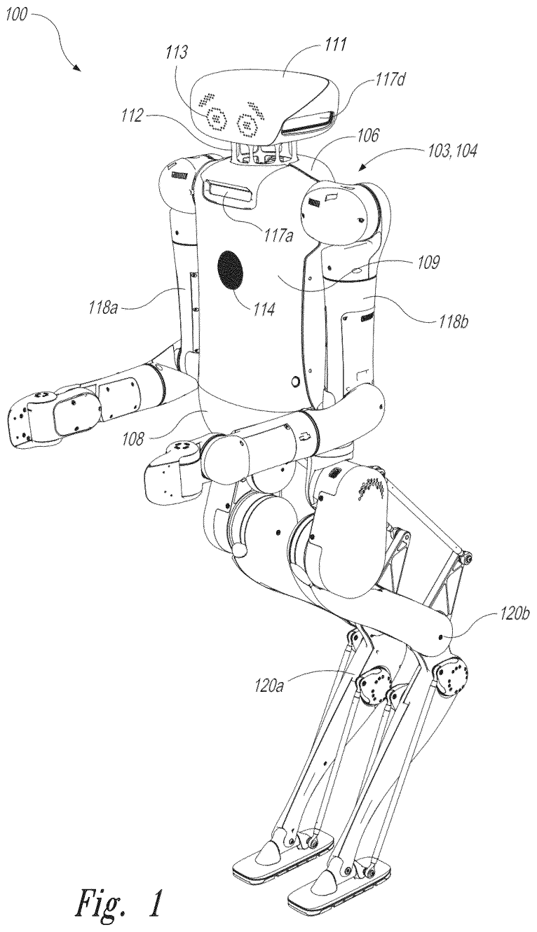

In the interest of clarity, some routine features of the implementations described herein are omitted. It will be appreciated that in the development of any actual implementation of the present invention, certain decisions must be made in order to achieve specific goals, and that different decisions can be made to achieve different goals without departing from the teachings of the invention. While certain implementations might be complex and time-consuming, they would nevertheless be routine to accomplish for those of ordinary skill in the art having the benefit of this disclosure. Disclosed herein are robots, and associated devices, systems, and methods. Features of robots, and associated devices, systems, and methods in accordance with various embodiments of the present invention are described below with reference to FIGS. 1-11. Although devices, systems, and methods may be described herein primarily or entirely in the context of warehouse robots, other contexts are within the scope of the present invention. For example, suitable features of described devices, systems, and methods can be implemented in the context of robots that operate in non-warehouse environments, such as in the context of terrain-mapping robots, in the context of social robots, etc. Furthermore, it should be understood, in general, that other devices, systems, and methods in addition to those disclosed herein are within the scope of the present invention. For example, devices, systems, and methods in accordance with embodiments of the present invention can have different and/or additional configurations, components, procedures, etc. than those disclosed herein. Moreover, devices, systems, and methods in accordance with embodiments of the present invention can be without one or more of the configurations, components, procedures, etc. disclosed herein without deviating from the present invention. Thus, more particularly, the disclosed subject matter is directed to methods of identifying an individual robot; identifying an individual robot(s) within a group; communicating with the identified individual robot as needed; initiating individual or group commands as required and in some preferred embodiments initiating a method of remote disablement of one, more than one, or all the robots in a group or fleet. In further embodiments, it may be necessary to perform: a shutdown of a single robot, a shutdown of multiple robots, and a large-scale shutdown of all robots in a group or fleet, where, in some embodiments, the shutdown will be performed from a safe distance, such as by a remote disablement. In embodiments described herein, disablement and shutdown may at times be used interchangeably.

### Examples of Robot Systems

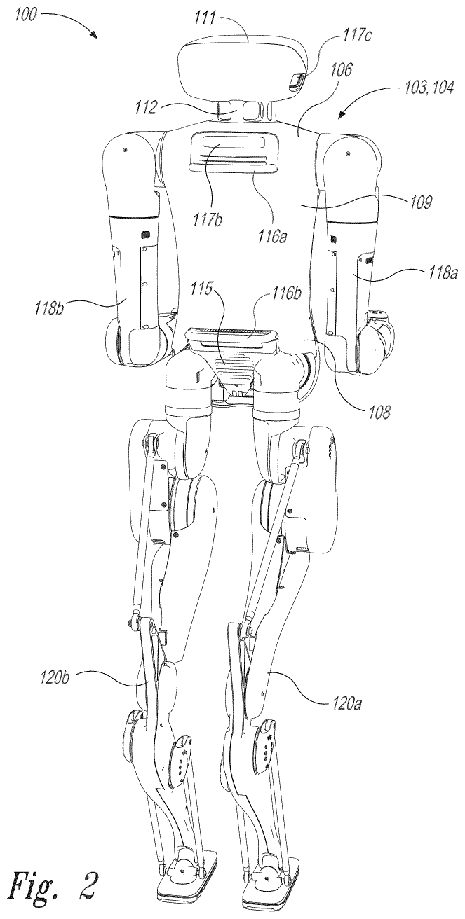

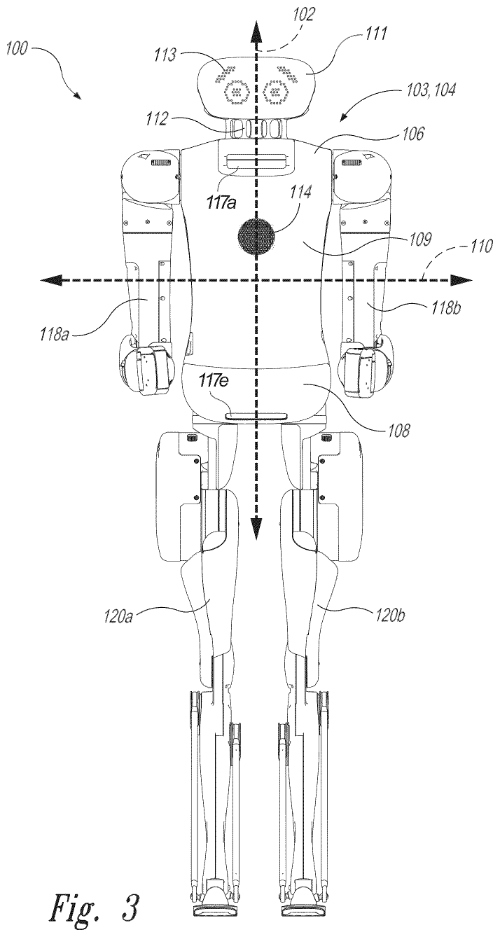

Disclosed herein, and illustrated in FIGS. 1 and 2 are different perspective views of a legged robot 100 in accordance with at least some embodiments of the present invention. FIG. 3 is a front profile view of the robot 100. As shown in FIGS. 1-3, the robot 100 can have a humanoid form. The robot 100 can include structures resembling human anatomy with respect to the features, positions, and/or other characteristics of such structures. In at least some cases, the robot 100 defines a midsagittal plane 102 about which the robot 100 is bilaterally symmetrical. In these and other cases, the robot 100 can be configured for bipedal locomotion similar to that of a human. Counterparts of the robot 100 can have other suitable forms and features. For example, a counterpart of the robot 100 can have a non-humanoid form, such as a canine form, an insectoid form, an arachnoid form, or a form with no animal analog. Furthermore a counterpart of the robot 100 can be asymmetrical or have symmetry other than bilateral. Still further, a counterpart of the robot 100 can be configured for non-bipedal locomotion. For example, a counterpart of the robot 100 can be configured for another type of legged locomotion (e.g quadrupedal locomotion, octo-pedal locomotion, etc.) and/or in some further embodiment wheeled locomotion, or continuous-track locomotion for example.

With reference again to FIGS. 1-3, the robot 100 can include a centrally disposed body 103 through which other structures of the robot 100 are interconnected. As all or a portion of the body 103, the robot 100 can include a torso 104 having a superior portion 106, an inferior portion 108, and an intermediate portion 109 there between. The robot 100 can define a transverse plane 110 from which the superior and inferior portions 106, 108 of the torso 104 are respectively superiorly and inferiorly spaced apart. The robot 100 can further include a head 111 superiorly spaced apart from the torso 104. The robot 100 can also include a neck 112 through which the head 111 is connected to the torso 104 via the superior portion 106 of the torso 104. The head 111 can have an anteriorly directed display 113 including light-emitting diodes selectively controllable to create a composite, pixelated image evocative of human facial expression. The robot 100 can further include an anteriorly directed audio transmissive window 114 at the intermediate portion 109 of the torso 104, a posteriorly directed exhaust vent 115 at the inferior portion 108 of the torso 104, and superior and inferior projections 116a, 116b extending, respectively, posteriorly from the superior portion 106 of the torso 104 and posteriorly from the inferior portion 108 of the torso 104. The robot 100 can still further include sensor arrays 117 (individually identified as sensor arrays 117a-117e) carried by the torso 104 and the head 111. The sensor arrays 117a, 117b can be at the superior portion 106 of the torso 104 and anteriorly and posteriorly directed, respectively. The sensor arrays 117c, 117d can be at opposite respective sides of the head 111 and can be directed in opposite respective lateral directions. The sensor array 117e can be at the inferior portion 108 of the torso 104 and directed anteriorly and inferiorly toward a ground level in front of the robot 100.

The robot 100 can further include articulated appendages carried by the torso 104. Among these articulated appendages, the robot 100 can include arms 118a, 118b and legs 120a, 120b. In at least some cases, the robot 100 is configured to manipulate objects via the arms 118a, 118b, such as bimanually. In these and other cases, the robot 100 can be configured to ambulate via the legs 120a, 120b, such as bipedally. Further embodiments of robot 100, are disclosed in U.S. non-provisional patent application Ser. No. 18/061,868, which is incorporated herein in its entirety by reference.

Examples of Electrical. Computer, and Software Systems

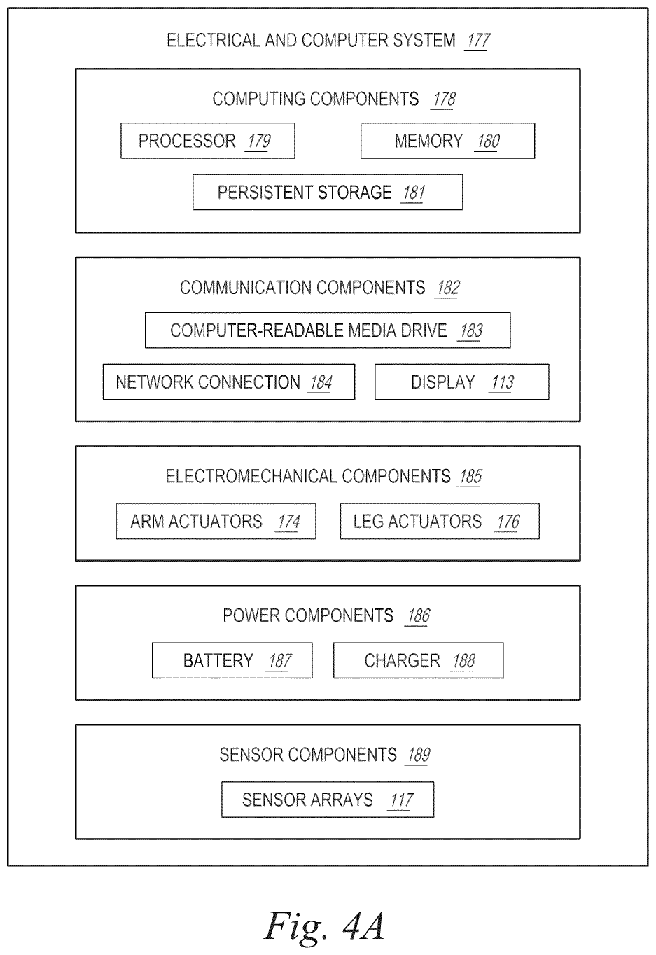

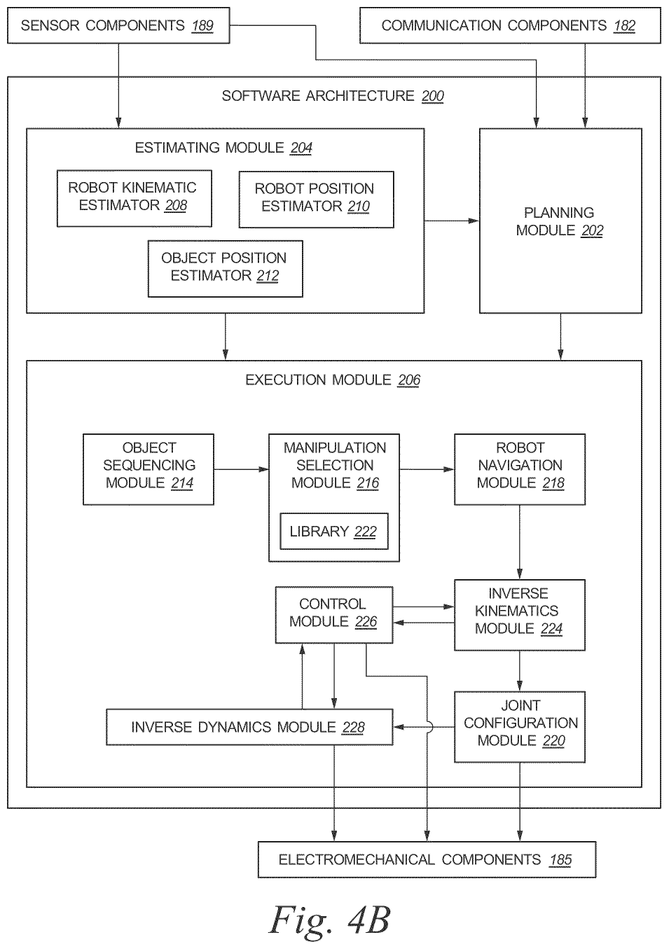

A representative embodiment of the electrical and computer systems 177 of a legged robot 100 as described herein, are illustrated in the block diagram of FIG. 4. When suitable, operations described elsewhere in this disclosure (e.g., movements of the robot 100, or a shutdown or disablement of the robot) can be implemented via this electrical and computer system 177 autonomously and/or in response to instructions from a user or an operative entity. As shown in FIG. 4, the electrical and computer system 177 can include computing components 178. The computing components 178 can include one or a plurality of processors 179, such as one or more general-purpose and/or special-purpose integrated circuits including digital logic gates for executing programs and/or for otherwise processing data. The computing components 178 can further include memory 180, such as one or more integrated circuits for storing data in use. The memory 180 can include a multithreaded program, an operating system including a kernel, device drivers, etc. The computing components 178 can further include persistent storage 181, such as a hard drive for persistently storing data. Examples of data that can be stored by the persistent storage 181 include diagnostic data, sensor data, configuration data, environmental data, and current-state data. The computing components 178 can collectively define a computer configured to manage, control, receive information from, deliver information to, and/or otherwise usefully interact with other components of the electrical and computer system 177.

The electrical and computer system 177 can further include communication components 182. The communication components 182 can include a computer-readable media drive 183 for reading computer programs and/or other data stored on computer-readable media. As one example, the computer-readable media drive 183 can be a flash-memory drive. The communication components 182 can further include a network connection 184 for connecting the robot 100 to other devices and systems, such as other robots and/or other computer systems. The network connection 184 can be wired and/or wireless and can be via the Internet, a Local Area Network (LAN), a Wide Area Network (WAN), a Personal Area Network (PAN) BLUETOOTH, WiFi, a cell phone network, etc. The network connection 184 can include networking hardware, such as routers, switches, transmitters, receivers, computer-readable transmission media, etc. The communication components 182 can further include the display 113 discussed above and/or other suitable components for communicating with a user. The robot 100 can use the communication components 182 for internal operations and/or to interact with devices and/or systems external to the robot 100, such as systems for providing contextual information about the environment in which the robot 100 operates and/or systems for changing operating conditions of the robot 100.

The electrical and computer system 177 can further include electromechanical components 185. The electromechanical components 185 can include the arm actuators 174 and the leg actuators 176 discussed above and/or other suitable components for implementing mechanical action within the robot 100. The electrical and computer system 177 can further include power components 186. The power components 186 can include a battery 187 and a charger 188. The battery 187 can be a lithium-ion battery, a lead-acid battery, or another suitable type. The charger 188 can include a connector (not shown) compatible with a power source (e.g., a wall outlet) and leads (also not shown) extending between the connector and the battery 187. In at least some cases, the robot 100 is configured to operate wirelessly via the battery 187 and to recharge occasionally via the charger 188.

Finally, the electrical and computer system 177 can include sensor components 189 for capturing, providing, and/or analyzing information about the robot 100 itself and/or the environment in which the robot 100 is operating. The sensor components 189 can include the sensor arrays 117 discussed above. At the sensor arrays 117 or at one or more other suitable locations, the robot 100 can include among the sensor components 189 a light sensor (e.g., a photoresistor), a sound sensor (e.g., a microphone), an accelerometer, a gyroscope, a tilt sensor, a location sensor (e.g., using the Global Positioning System), a distance sensor, a contact sensor, and/or a proximity sensor, among other examples. The robot 100 can include one or more sensors in a sensor system, such as a vision system, an electromagnetic sensor such as used with a remote communications device, a light detection and ranging (LIDAR) system, a sound navigation and ranging (SONAR) system, etc. In at least some cases, the robot 100 monitors itself and/or its environment in real-time or in near real-time. Moreover, the robot 100 may use acquired sensor data as a basis for decision-making via the computing components 178.

Components of the electrical and computer system 177 can be connected to one another and/or to other components of the robot 100 via suitable conductors, transmitters, receivers, beacons, circuitry, etc, wherein some embodiments a beacon may transmit, emit or receive a signal. While the electrical and computer system 177 configured as described above may be used to support operation of the robot 100, it should be appreciated that the robot 100 may be operated using devices of various types and configurations and that such devices may have various components and levels of responsibility. For example, the robot 100 may employ individual computer systems or controllers to manage discrete aspects of its operations, such as an individual computer system or controller to perform computer vision operations, a separate computer system or controller to perform power management, or a remote device to identify, communicate, and disable a robot 100 in some situations and embodiments etc. In some cases, the robot 100 employs the electrical and computer system 177 to control physical aspects of the robot 100 according to one or more designated rules encoded in software. For example, these rules can include minimums and/or maximums, such as a maximum degree of rotation for a joint, a maximum speed at which a component is allowed to move, a maximum heat value experienced at any robot 100 component, a maximum acceleration rate for one or more components, etc. The robot 100 may include any number of mechanical aspects and associated rules, which may be based on or otherwise configured in accordance with the purpose of and/or functions performed by the robot 100. In some embodiments, encoded software protocols perform system checks comprising allowed minimum and maximum values in order to determine the operational state of robot 100. In some embodiments, a robot state or robot operational state may be one of, but not limited to: on, stalled, off-line, or shutdown.

Software features of the robot 100 may take the form of computer-executable instructions, such as program modules executable by the computing components 178. Generally, program modules include routines, programs, objects, components, data structures, and/or the like configured to perform particular tasks or to implement particular abstract data types and may be encrypted. Furthermore, the functionality of the program modules may be combined or distributed as desired in various examples. Moreover, control scripts may be implemented in any suitable manner, such as in C/C++ or Python. The functionality of the program modules may be combined or distributed in various embodiments, including cloud-based implementations, web applications, mobile applications for mobile devices, etc.

Furthermore, certain aspects of the present invention can be embodied in a special purpose computer or data processor, such as application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present invention, such as certain functions, may be described as being performed on a single device, these aspects, when suitable, can also be practiced in distributed computing environments where functions or modules are shared among different processing devices linked through a communications network such as a Local Area Network (LAN), Wide Area Network (WAN), or the Internet. In a distributed computing environment, program modules and other components may be located in both local and remote memory storage and other devices, which may be in communication via one or more wired and/or wireless communication channels.

Aspects of the present invention may be stored or distributed on tangible computer-readable media, which can include volatile and/or non-volatile storage components, such as magnetically or optically readable computer media, hard-wired or preprogrammed chips (e.g., EEPROM semiconductor chips), nano-invention memory, biological memory, or other computer-readable storage media. Alternatively, computer-implemented instructions, data structures, screen displays, and other data under aspects of the present invention may be distributed (encrypted or otherwise) over the Internet or over other networks (including wireless networks), on a propagated signal on a propagation medium (e.g., electromagnetic wave(s), sound wave(s), etc.) over a period of time, or they may be provided on any analog or digital network (packet switched, circuit switched, or other scheme). Furthermore, the term computer-readable storage medium does not encompass signals (e.g., propagating signals) or transitory media. One of ordinary skill in the art will recognize that various components of the robot 100 may communicate via any number of wired and/or wireless communication techniques and that elements of the robot 100 may be distributed rather than located in a single monolithic entity. Finally, electrical and computing aspects of robots in accordance with various embodiments of the present invention may operate in environments and/or according to processes other than the environments and processes described above.

A robot may be required to shutdown for a number of reasons with a varying degree of urgency. For example, it may be necessary to shut a robot down simply for routine maintenance, or for transport to a different location, or in any other low risk scenario which is thus considered a soft shutdown or a cessation protocol. A shutdown may be emergent or a hard shutdown, wherein a robot is potentially in danger of being impaired, or causing impairment to facilities, such as by moving out of its defined work area, or whilst performing a protocol, connection with and/or control of the robot are lost and immediate shutdown is required. A requirement for remote disablement or shutdown may be identified by a number of factors. Non-limiting examples include: loss of communication with a robot, such as by loss of a wireless connection; a loss of a heartbeat or watchdog signal between a beacon and a robot, wherein the loss of a signal or a return signal from a robot is an indicator of the need to shutdown the robot; or a robot moving out of range of a signal for a command protocol. Further, an operator may visually recognize that a robot has malfunctioned or moved into an area that has not been designated a robot work area; and further still a robot may independently perform a self-diagnostic step, or be required to perform a self diagnostic step by command of an operator and when a predefined status is not returned the robot is shut down. Additionally, a robot may be pre-programmed for a hierarchical shutdown, such as: a system or an operator identifies (by any method disclosed herein) a robot necessitating shutdown, communicates with and initiates a command to the robot to perform a shutdown, if a predefined criteria is met, such as a return of a heartbeat signal or a data signal/data signal match, then a robot will power down and perform a soft shutdown, but if a predefined criteria (such as a data signal/data signal match/heartbeat) is not met or returned, a hard shutdown will be performed, wherein electrical power is immediately disabled. The above embodiments and others are thus disclosed herein.

Identifying and Communicating with a Robot

Robots, individual or groups thereof, may be deployed in a variety of roles and environments, and may function: solely in the vicinity of other robots; have minimal or periodic interaction with humans; work alongside humans; and work directly with humans, in order to carry out a wide variety of tasks. Such roles will therefore require differing degrees of human/robot interactions. It is therefore necessary for humans to be able to rapidly identify and communicate with an individual robot in order to parse command protocols that are required to initiate and control robot tasks. It may be necessary to quickly shutdown a robot, such as in an emergency situation wherein a hard shutdown is required, or under other circumstances it may be necessary to place the robot in a controlled cessation protocol. In some embodiments the robots identified, and commanded herein are legged robots, such as the robot discussed and illustrated in FIGS. 1-3 herein.

In certain embodiments, a hard shutdown, as the term is used herein, comprises immediate removal of power to the robot actuators, such as by switching off the electrical power to the electric motor(s) of the robot by electromechanical switching devices or triggering of fuses; and in other embodiments by removing the power needed to generate a torque or force in an electrical motor using the safe torque off (STO) function of the power drive system, and may be termed a CAT-0 shutdown. A hard shutdown may, in certain embodiments cause significant mechanical and or electrical impairment to the robot, and in some embodiments the robot will be irrevocably damaged. Whilst in some situations, such as an emergency situation, it may be necessary to perform a hard shutdown and induce irrevocable impairment to the robot, a soft shutdown, which may in some embodiments, be termed a CAT-1 negates such outcomes and is preferable in most non-emergency situations.

In certain embodiments, under non-emergent conditions, a soft shutdown may be implemented. A soft shutdown, as the term is used herein, comprises stopping movements and operations with power available to the robot actuators to achieve the stop, and then removal of power when the stop is achieved. In some embodiments the robot is brought to a stop or a halt, and then powered down. In some embodiments, the removal of power may be selective, such that all power to every actuator is not removed. Such deceleration of motion, and then removal of the electrical power to the robot motor(s) when motion has ceased, may in some embodiments be controlled by activating electromechanical switching devices, or in other embodiments by removal or reduction of power needed to generate a torque or force achieved by electromechanical switching mechanisms, or by electronic means.

A soft shutdown may allow for: a robot to safely place down a payload; for a robot to be placed in a safe-positional mode or safe limited position, or any position that is dynamically stable, such as moving from a standing position to a crouching, a squatting, a sitting, or a collapsed position. A collapsed position for example, may be a controlled collapsed position, such that the robot may be controlled to move to or from the collapsed position, through any combination of a controlled sit, squat, crouch or stand, using controlled motions, such as a but not limited to a push-up utilizing the robots arms and/or end effectors, independently or harmonized with torso and/or leg and feet movement against a surface. The controlled collapse position may comprise the robot's chest being oriented to be adjacent to a surface such as the floor, or the robot's back being adjacent to the surface onto which the robot collapses.

In some embodiments, a soft shutdown may allow a robot that is in motion, such as taking a stride, to return to a safe limited position, safe-state or a safe pose (which as defined and used herein, are interchangeable) before removal of electrical power to the robot. In other embodiments of a soft shutdown, the robot may return to a docking station before powering down. In certain embodiments, a soft shutdown takes two to ten seconds, measured from the time at which the soft shutdown is initiated until electrical power has been removed to the robot and the robot is powered down. In some embodiments, the time for soft shutdown (CAT-1) is three to seven seconds or any increment thereof. A certain embodiment of a controlled soft shutdown comprises placing a robot that is functioning in a work cell environment into a safe-state in five to seven seconds when a soft shutdown signal is initiated. The robot will move to a stand mode which is dynamically stable, and then either place down its payload or, if need be, drop its payload by opening its arms wider than the dimensions of the payload. The robot will then place its arms by its side, and by dampening of the motors, move gracefully in a controlled manner to a forward sitting position (chest adjacent the ground) or a backward sitting position (back adjacent to the ground) wherein the robot arms contact the ground and stabilize the robot body as it sits down. The robot is then completely powered down by the removal of electrical power to the robot. Such a soft shutdown may be implemented by the requirement of a human to enter a work cell, or in order to cease a current robot function, or correct a robot behavior.

Considering the block diagram of FIG. 4B, the robot 100 comprises a software architecture 200 which may include a planning module 202, an estimating module 204, and an execution module 206 operably associated with one another. The planning module 202 can be configured to relay or to generate a plan corresponding to a remote disablement, such as a soft shut down of robot 100 as disclosed herein.

In some cases, the planning module 202 receives information from the communication components 182 (such as the electromagnetic signals disclosed herein) and relays or generates a plan based in part on the information received. For example, the planning module 202 can receive a command from a user via the communication components 182 and relay the command as a plan. In another example, the planning module 202 can receive a command from a user via the communication components 182 and generate a plan related to the command. In a further example, the planning module 202 can generate a plan without receiving a command from a user, such as at a predetermined time or in response to information about a current state of the robot 100 or the environment from the sensor components 189. A requirement to enable a soft shutdown of a robot within a work cell would follow the logic implemented by such planning modules when for example a human may need to enter a workcell, a worker unexpectedly enters a work cell, or modify or correct a robot behavior.

The estimating module 204 can provide additional information in assessing the state of the robot, and/or its operating environment, such that the estimating module receives information from the sensor components 189 as described herein and can generate estimates in real time or in near real time to inform the generating and/or executing of a plan. The estimating module 204 can include a robot kinematic estimator 208, a robot position estimator 210, and an object position estimator 212. The robot kinematic estimator 208 can generate an estimate of a current kinematic state of the robot 100 (e.g., balanced, off-balance, walking, standing, etc.) and estimates of positions of individual joints of the robot 100. The robot position estimator 210 can generate a current estimate of a position or pose of the robot 100 within an environment. The robot position can be a set of coordinates and can be based on, for example, perception information and/or GPS information. Perception information relevant to the robot position includes, among other examples, information corresponding to distances between the robot 100 and landmarks in its environment as detected, for example, via a LIDAR system of the robot 100. The object position estimator 212 can generate estimates of the positions of relevant objects (e.g., payloads to be manipulated, other robots, objects, or operators) in an environment. As with the robot position, the object positions can be sets of coordinates and can be based on perception information, whether that perception information is real-time or historical.

The execution module 206 can be configured to receive a plan from the planning module 202 and estimates from the estimating module 204. The execution module 206 can include an object sequencing module 214, a manipulation selection module 216, a robot navigation module 218, and a joint configuration module 220. The planning module 202 can be configured to send a plan to the object sequencing module 214, to the manipulation selection module 216, to the robot navigation module 218, or to the joint configuration module 220 based on attributes of the plan. For example, when a plan includes explicit instructions for positions of the electromechanical components 185, the planning module 202 can send the plan to the execution module 206 via the joint configuration module 220, such as a user requiring a soft shutdown that places the robot in a fully collapsed position, may communicate to the electromechanical components via the joint configuration module 220 the required endpoint coordinated for the robot limbs. In another example, when a plan does not require manipulating an object such as moving or placing a payload before moving into a safe limited position, the planning module 202 can send the plan to the execution module 206 via the robot navigation module 218.

In another example, when a plan concerns only one object and the object is remote to the robot 100, the planning module 202 can send the plan to the execution module 206 via the manipulation selection module 216, such as requiring that a payload is placed in a safe position before the robot moves to a safe limited position. As a further example, when a plan concerns assessing and implementing a number of necessary steps prior to moving the robot into a safe limited position and then powering down the robot, planning module 202 may send the plan to the execution module 206 via the object sequencing module 214. The object sequencing module 214 can receive one or more estimates from the estimating module 204 and can generate a sequence in which multiple steps are to be executed. For example, the object sequencing module 214 can query the estimating module 204 for current locations of a number of payloads or objects in the vicinity of the robot. The object sequencing module 214 can then assign the objects an order, convert the order into a queue, and pass the queue to the manipulation selection module 216. The manipulation selection module 216 can include a library 222 including two or more different motion sequences that can be used to manipulate a payload or object, and place it in a safe position or environment ahead of powering down the robot. The manipulation selection module 216 can then select a motion sequence for example, for moving a payload based on its positional coordinates.

The robot navigation module 218 can generate targets for different parts of the robot 100 further to a plan or to a portion of a plan being executed. Examples of targets include positions of the robot limbs such as feet 158a, 158b in the environment. The robot navigation module 218 can update these targets continuously or near continuously based on information from the estimating module 204. The execution module 206 can further include an inverse kinematics module 224 that translates the targets from the robot navigation module 218 into joint configurations throughout the robot 100. The execution module 206 can also include a control module 226 that receives joint configurations from the inverse kinematics module 224 and generates joint parameters (e.g., positions, velocities, accelerations, decelerations etc.) to be executed by the robot 100 to achieve these joint configurations. Similar to the control module 226, the joint configuration module 220 can generate joint parameters (e.g., positions, velocities, accelerations, and decelerations etc.) to be executed by the robot 100 to achieve joint configurations received from the inverse kinematics module 224 or from the planning module 202, wherein for example in a soft shutdown the planning module sends a plan to the joint configuration module to decelerate and position the robot into a safe limited position before the powering down of the motors by the electromechanical components 185. In many embodiments, in order to address soft shutdowns where a robot is not in a dynamic interaction with the environment or a payload, the control module 226 and the joint configuration module 220 can send joint parameters directly to the electromechanical components 185 for execution, such that the robot is placed in a safe limited position and the motors and actuators powered down.

As discussed, there are a number of different types of shutdowns, which may result in different end states achieved in different timeframes. In some embodiments, a shutdown may be initiated by a command protocol, wherein and as described above, a soft shutdown allows for a legged robot to finish a task, such as safely placing a payload in a required position before returning to an idle area or a charging dock, other shutdowns may require that the legged robot sit down in a controlled manner and power off, while in other circumstances the shutdown may require that the legged robot is immediately powered down or de-energized such as in an emergent situation. Such an emergent shutdown may be a forced stop. In such embodiments, a signal received at the receptor or sensor on the robot will trigger an instant and rapid emergency shutdown. In some embodiments the signal may activate a fuse, such as an electromechanical fuse in order to unconditionally compromise the robot circuitry in order to deactivate the robot. In some other embodiments, the signal will trigger a metal-oxide-semiconductor field-effect transistor (MOSFET) switch in order to deactivate the robot. In other embodiments, a busbar switch may be activated to deactivate the robot. Fuses of the robot circuit may be triggered by an electrostatic discharge (ESD) touch such that a high voltage is discharged through the system when the “device” is touched by a charged body; or may be triggered by a directed electromagnetic signal. In each case, a forced stop or a forced halt procedure guarantees to deactivate or cause a force-halt of the selected robot.

In some embodiments, the type of shutdown may be governed by the allowable time window for a shutdown, such as under emergent situations, the time from identifying a robot requiring shutdown to issuing a command or protocol and achieving shutdown may be less than 100 seconds, less than 10 seconds, or in other embodiments less than 1 second, such as in 0.1 of a second or 0.01 of a second, or 0.001 of a second, in order to avoid a negative consequence, or in other embodiments, response time may be in the order of 10, 20, 30, 40, 50, 60, 70, 80, 90, or 100 seconds or more. By contrast, a controlled cessation may be implemented in a less emergent and more routine scenario, wherein for example, a controlled cessation protocol may be referred to as a system controlled shutdown or a soft shutdown. As used herein, shutdown and disablement are synonymous.

In some embodiments, a shutdown of the robot may be initiated by a human operator or may be auto-generated. The latter case may be implemented by a software program or logic gate, wherein a predetermined parameter is not met for example, and wherein the program or gate executes on an individual robot; or on a network that communicates with a robot or group of robots such as on a local area network. In some embodiments, a further robot may perform a shutdown operation on a first robot, either by direct or indirect contact, or by virtue of a shared network. In an emergency situation an operator may be a member of the public.

Methods of identifying requirements of a shutdown may comprise an operator visually reporting a situation or a behavior requiring shutdown, such as, but not limited to a robot moving outside a predefined work area, an external body encroaching on or moving into a robot's defined workspace, or a robot system malfunction. An example of such a situation requiring a shutdown is when a robot is functioning within a workcell, and wherein an observer identifies that a robot is performing a task incorrectly, and requires a soft shutdown in order to refocus the robot's task. Similarly, it may be necessary for a user/observer to initiate a hard shutdown if a human was to move into a robots functional space, or vice versa within a workcell. Other embodiments of identifying the necessity of a robot shutdown may comprise a robot self reporting or a robot peer reporting a system or robot anomaly, further embodiments of reporting a condition requiring shutdown may comprise environmental monitoring of a robot working environment (such as a warehouse space) by automated and non-automated systems and programs.

A shutdown protocol may be communicated between a robot and an operator, system, or other user and may be implemented using a wide variety of technologies. The I/O components may include communication components 182 operable to couple the robot to a network or devices. Some non-limiting examples of communication components include a network interface component or another suitable device to interface with a network. In further examples, the communication components 182 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices may be housed within another machine or any of a wide variety of peripheral devices, or may be remote devices as described herein. Such devices may be handheld, comprise personal protective equipment, be wearable, or remotely mounted at location that is distal or proximal to the target robot. In some embodiments distal is greater than 5 meters from a robot, and proximal is closer than 5 meters from the robot requiring commanding to perform a task, such as a remote disablement. In some embodiments, a remote device is configured to comprise a transmitter, such as an electromagnetic transmitter, in other embodiments, a remote device further comprises a sensor such that the sensor may receive a signal, and decode, process or interpret such a signal. A device sensor may be an electromagnetic sensor such as a photodiode, a pyroelectric sensor, a thermal sensor or another suitable sensor.

Additional communication components may detect identifiers or signals or include components operable to detect identifiers or signals. For example, the communication components may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response code, Aztec code, Data Matrix, Dataglyph, MaxiCode, PDF417, Ultra Code, UCC RSS-2D barcode, and other optical codes), or acoustic detection components (e.g., microphones to identify tagged audio signals). In addition, a variety of information may be derived via the communication components, such as location via Internet Protocol (IP) geolocation, location via Wi-Fi® signal triangulation, location via detecting an NFC beacon signal that may indicate a particular location, transponder communications, including audio and ultrasonic communications and so forth.

In some embodiments, at least one robot in a group of robots may be identified as requiring shutdown, in other instances more than one robot in a group may be identified as requiring shutdown, and in further embodiments all robots in a group may be identified as requiring shutdown, wherein a shutdown may be a remote disablement. In some embodiments, wherein less than all the robots in a group receive the same command, the group of robots is differentially signaled, differentially controlled or differentially commanded.

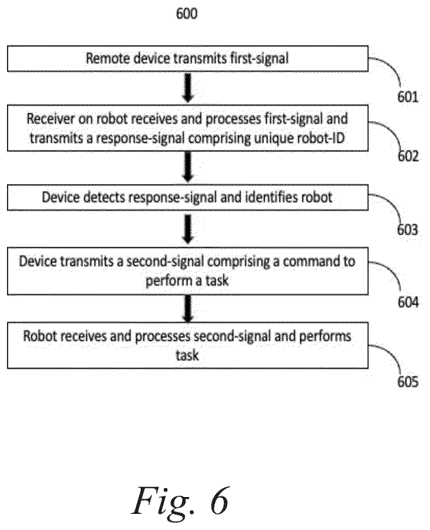

Therefore, disclosed herein are methods of communicating with and identifying each robot within a group of robots, and in some embodiments differentially commanding at least one robot within the group. One such preferred embodiment comprises the remote disablement of at least one robot within the group (FIGS. 6-8 provide flowcharts of such embodiments). However, all or less than all the robots in a group may be commanded in a similar fashion, but with other command protocols that implement tasks other than a hard or a soft shutdown.

Methods of identifying, communicating with, commanding and performing a remote shutdown or disablement of an individual robot, or at least one deployed robot among a group of robots may include the utilization of one or more of the following technologies:

### QR Codes

In some embodiments, a method of identifying a robot comprises each robot having a unique Quick Reference (QR) code or QR pattern, wherein the code is visibly located on the robot. A handheld device comprising a QR code reader may then be used to scan/read each QR pattern located on each of the robots, wherein each QR code comprises a unique ID for each robot and thereby identifies each individual robot within a group. In some embodiments, the device scanning the QR code may be distal from the identified robot. In other embodiments the device may be proximal to the identified robot.

In certain embodiments, the handheld device can also issue subsequent commands to each individual robot by broadcasting over different mediums and selected channels. In other embodiments, a command may be issued to initiate a shutdown or remote disablement of a selected robot, such that the command may be broadcast only to the selected robot which has been identified by its unique QR code ID, and thereby shutdown only the robot comprising the specified QR ID. The method may be repeated in order to identify more than one robot in the group that requires identification and requires a further command such as requiring a remote disablement. The method may be, in some embodiments, expanded to include all robots in a group as needed.

In a further embodiment, a QR code displayed by an operator, such as on a screen of a remote device, or on any other medium that constitutes a display or a readable source, may be read by a robot comprising a camera or a QR reader, such that a QR code comprises a robot command and the command is recognized and executed by the robot. In some embodiments, an operator may display a QR code which the robot recognizes, such as a stop command, or a shutdown command, and the QR code displayed by the operator may therefore initiate disablement of an individual robot. In some further embodiments, an operator may display a QR code that comprises a command such as but not limited to a hard shutdown command, wherein the command code is unique to only one robot, hence even if all robots read the same code only the target robot to which the code belongs, or is tagged to will initiate shut down.

In some other embodiments, an operator, by virtue of scanning a QR code located on a particular robot will be paired to that specific robot. Similarly, a robot scanning a QR code displayed by an operator, such as on a screen or a remote device, will also facilitate the pairing of a device to that particular robot, and further facilitate transmission of commands and data acquisition to and from only the particularly paired and identified robot. In some such embodiments, such pairing links the identified robot to the remote device once permission is granted, and specific commanding of the paired robot by the operative entity thus occurs. In some other embodiments, a robot may be identified by a Liquid crystal display (LCD) comprising a code visibly located on the robot. An operative entity can identify the robot visually or by any suitable method of scanning the code, and may further compare the LCD ID to a roster or register to confirm the identity of the robot. A further command to shutdown can be transmitted as needed by a remote device as described herein. Further, an LCD may disclose additional information about the identified robot, such as whether the robot is assigned a particular task; to a particular operation; a particular group of robots; or is functioning autonomously.

### Electromagnetic Signaling

Other embodiments of identifying, communicating with, and commanding a robot utilize an electromagnetic signal which may comprise any suitable frequency range. In some embodiments, a device may transmit an electromagnetic signal such as those comprising radio, gamma, and microwaves, IR, as well as visible light to a receiver located on a robot. Such a device may be remote, handheld, wearable, comprising personal protective equipment, fixed, or a semi fixed device, wherein the device may be a directional command wand or device. In certain embodiments the device may be used in a bi-directional fashion in order to introduce redundancy and diversity into the command system. For example, in some methods of identifying a robot, an operator may by virtue of remote device, transmit an electromagnetic signal, such as an IR signal to a robot while also pointing a directional IR detector at a receiving beacon mounted on the robot. In such an embodiment, both the robot and operator are each a source and a sensor for directional IR beam, providing redundancy to a system which may be utilized to provide a method of identifying a robot and implementing should it be required, a remote disablement. In some embodiments the IR sensor may be active or may be passive. Active infrared sensors both emit and detect infrared radiation, and thereby, active IR sensors have two parts: a light emitting diode (LED) and a receiver. When a body comes close to the sensor, the infrared light from the LED reflects off of the object and is detected by the receiver. Thereby, in some embodiments, an active IR sensor may act as a proximity sensor in order for a robot within a group to detect another robot, or an obstacle. In other embodiments, an IR sensor may be a passive sensor, which detects only infrared radiation by virtue, for example of a pyroelectric sensor or a photodiode, or a heat sensor to capture a thermal energy change.

In some other embodiments, a device for identifying, communicating with, and in some embodiments commanding a robot to perform a remote disablement or shutdown comprises an electromagnetic transmitter. In some embodiments, the device is a handheld device that transmits an electromagnetic signal over a predefined frequency range such as but not limited to an IR signal range, which is received at a target receiver, sensor, or beacon located on the robot. In a further embodiment, the device may also comprise a visible light beam that is coupled to the IR signal, such that the visible light beam allows the operator to focus the IR signal by virtue of the visible beam and select the correct robot. A visible light beam may be coupled to other embodiments of devices described herein in order to provide a visual confirmation that an operator using a remote device selects the correct robot for communication, command, and remote shutdown or disablement.

In another embodiment a laser scanner may be comprised on the remote device, wherein a laser scanner is an optical sensor which monitors an allowed zone in which a robot is configured to perform a function, by scanning the area around it on a single plane with infrared light beams, if a robot moves outside of the allowed zone the optical sensor is activated, and a second electromagnetic signal is transmitted to the robot and a shutdown protocol is activated, wherein the shutdown may be a hierarchical shutdown, a soft shutdown, or a hard shutdown as designated by a predefined criteria or data signal match, or by command of an operating entity.

In some embodiments, when an IR/electromagnetic signal is received at the sensor, receptor, or beacon located on a robot, the robot will immediately initiate a shutdown or disablement.

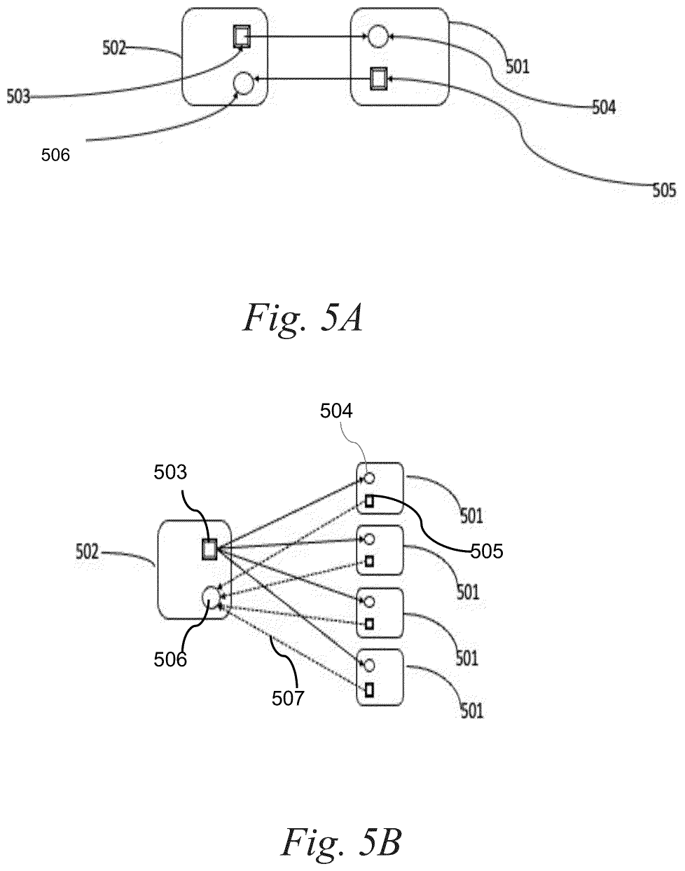

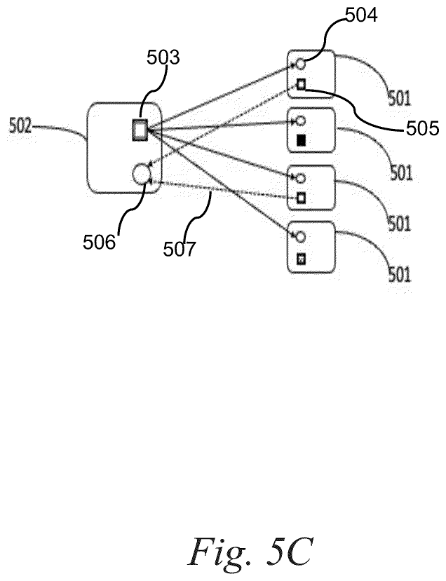

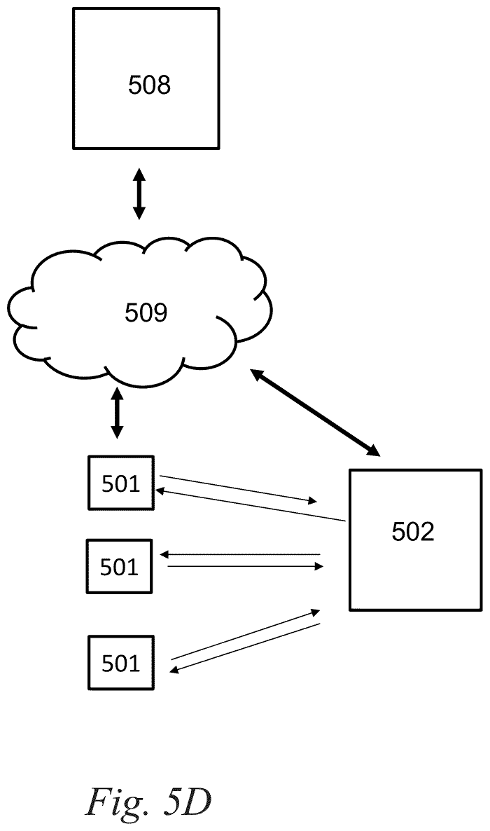

In still other embodiments, as illustrated in FIG. 5A, and the flowchart of FIG. 6, when a robot 501 receives an IR electromagnetic signal at a sensor 504, from a transmitter 503 on a remote device 502, 601; the robot will transmit a response-signal from a transmitter 505, which is then received at a sensor 506 located on remote device 502. In certain embodiments, the response-signal comprises a unique robot ID 602, and once received and recognized by the device 502, 603, a second-signal (not shown) is transmitted 604 from the device 502 to the robot 501 and causes the robot 501 to initiate a task 605, such as, but not limited to, a robot shutdown or disablement.

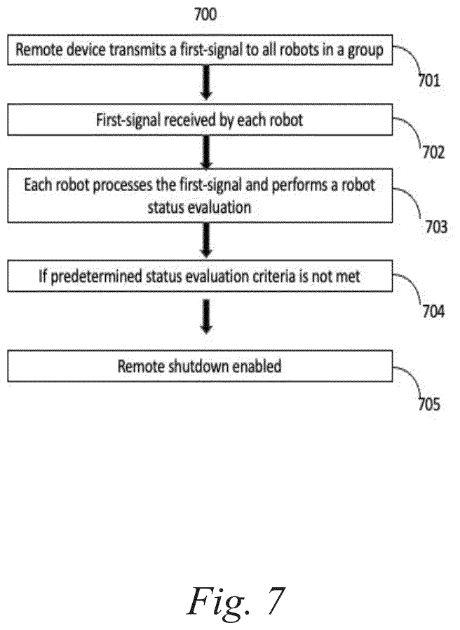

Similarly, and as further illustrated in FIG. 5B and the flowchart of FIG. 6, a remote device transmits 601 a first-signal to a group of robots comprising any number (n) of robots 501, each robot then receives an IR electromagnetic signal, from the transmitter 503 of remote device 502 at a sensor 504. Each robot 501 will then produce a response or confirmation signal, which is transmitted from a transmitter 505 located on the robot, and received at a sensor 506 located on the remote device 502. The signal is a unique robot ID 507, and once the signal is received and recognized at the device 502, a second-signal (not shown) is transmitted by the device, wherein the second-signal results in a task, such as, but not limited to, a robot shutdown or disablement as further illustrated in FIG. 7.

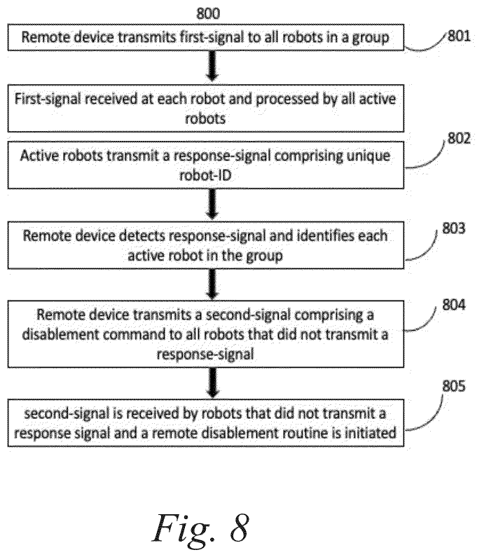

In still further embodiments, as illustrated in FIG. 5C and the flowchart of FIG. 8, a group of robots, comprising any number (n) of robot 501, having a sensor 504 which receives an IR electromagnetic signal from a transmitter 503 located on remote device 502. On receiving the signal at a sensor 504, each robot transmits, via a transmitter 505, a response or confirmation signal, which is received at a sensor 506 located on the remote device 502, wherein the signal is unique to each robot. Once the signal is received, a program compares the robot IDs to a predetermined robot register, and if a robot does not return a response-signal (such as in the second and fourth robot) the program will recognize which robots 501 did not provide an ID, the program may then for example initiate the transmission from the remote device, of a second-signal (not illustrated), wherein the second-signal results in a robot shutdown or disablement of only the robots that did not transmit a robot ID/response-signal 507. In other embodiments however, the second-signal may be an encoded signal, or a signal providing any other command that an operating entity should wish to utilize in order to control a robot or group of robots. The robot register may be stored at the remote device 502, wherein, in some embodiments a remote device may comprise one or more processors, and a computer-readable storage medium storing instructions that, when executed by the one or more processors, allow the remote device to perform functions comprising storing data and comparing data, such that a stored robot register may be compared to data transmitted by the robot, such as a unique robot ID, and associated robot status identifiers, or communicated to the remote device via an Fleet Management System (FMS), 508 or a warehouse control system, over the network 509, as illustrated in FIG. 5D.

In some other embodiments, the remote device transmits an electromagnetic signal, over a predefined frequency range, which when received, activates a light sensor on the robot. The activated light sensor provides a visible indicator such as a light signal, which may be frequency coded, color coded, a hologram, or any other visible signal to the operator indicating that the robot has received the IR signal. The initial signal is further processed by the identified robot and the robot system initiates a response, wherein in some embodiments, the response is a shutdown or disablement. In other embodiments, a second-signal will be transmitted by the device after the operator has received visual confirmation that the correct robot has been selected, the signal may be encoded to command a shut down or perform any other suitable task required by the operating entity.

In some other embodiments, the robot targeted by the operator will generate a response-signal that is specific to the robot, such that the operator not only visually selects the robot, but confirms which robot has been “selected” by virtue of the robot issuing a “response-signal” which is identified by the handheld device. Such a response-signal comprises a unique robot ID, which may be for example a 2D-code, 3D-code, a QR code, an encoded electromagnetic signal, or a haptic feedback signal. In such embodiments, once the device has identified and confirmation that the correct robot has been selected, the operator may then transmit a second-signal that communicates a particular command or shutdown. Thus, in some embodiments the second-signal may be encoded to provide a specific command to the robot, such as but not limited to a shutdown or disablement protocol.

In another embodiment, a method of initiating a remote shutdown (or disablement) of at least one deployed robot selected from a group of robots is disclosed (an embodiment of which is illustrated in FIG. 7). The method comprises, transmitting an electromagnetic signal such as an IR signal from a remote device 701 and receiving the signal at a target receiver, sensor or beacon located on each of the robots 702 in the group. Each receiver located on each of the robots processes the signal and performs a pre-defined or pre-programmed status evaluation in response to the signal 703. If the robot returns a satisfactory status evaluation the robot may continue to function as previously commanded, or perform a new task as required or signaled by the operator. If, however, the pre-defined or pre-determined status evaluation is not met 704, the robot performs a shutdown or is remotely disabled 705. Any number of robots within the group that do not meet the status evaluation criteria may be disabled in this fashion, such that if required all robots may be disabled as necessary. Heartbeat or watchdog protocols may be utilized and evaluated as robot status evaluation criteria, as will be discussed below.

In some embodiments, a watchdog protocol comprises circuits involving relays or switches, the circuits in some embodiments operate on a “normally closed circuit,” or a circuit that transmits through the switch to the receiving computer in a typical operating state. In such circuits, when a system anomaly occurs, or a hard-wired emergency stop is engaged, or a fuse or circuit breaker, for example, is triggered, the circuit may be opened, and a signal will be generated to deactivate the robot. In certain other embodiments, a watchdog protocol is used to detect and recover from communications and computer hardware malfunctions. During normal operation, a computer comprising the robot or a computer on an area network for example, will regularly reset the watchdog timer to prevent the timer from expiring. If there is a malfunction with the computer, or robot systems and the watchdog timer expires, the safety system will trigger the robot to halt until a corrective action has been taken. When halted under such conditions, the robot is in a “safe-state.” Accordingly, the robot is put into safe-state, cession, or soft shutdown when there is a communication or hardware malfunction on the remote device, monitoring computer or embedded system.

Similar to the watchdog timer, an individual robot, a group of robots, or a computer network monitoring or controlling a robot or group of robots may be configured to comprise a “heartbeat” such that the receiver system on the robot for example must receive a signal in a specific interval under predefined conditions. If the receiver missed a predetermined number of “heartbeats,” a safety system triggers and the robot halts operation, such as by cutting power to the robot by triggering a fuse in the robot circuitry or by executing a safety program that places the system in a soft shutdown or cession protocol. A watchdog system or a “heartbeat” may in some embodiments comprise a robot or system status evaluation protocol.

### RF-Based Directional Signals

In other embodiments, a device may transmit a radio frequency RF-based directional signal, that is received at a receiver or detector on a robot. The RF signal may be coupled to a visible light beam (for example a laser, or a “laser pointer”) such that the visible signal is emitted by a laser diode. Various laser diodes can emit visible light. Non-limiting examples are GaInP and AlGaInP-based red laser diodes, and GaN-based blue-emitting diodes. The visible light emitted by the laser diode may allow the operator to focus the RF signal to the desired robot. The device may further comprise a directional antenna wand, and the receiver on the robot detects the RF signal in an unlicensed frequency band (for example at 900 MHZ, 2.4 GHz and 5.8 GHz). The operator can therefore adjust the power and the frequency of the RF signal such as to affect a single nearby robot or all robots in a defined radius or distance, and such that the signal may cause a remote disablement or shutdown. In other embodiments, the RF signal may be encoded and can comprise a command, such as a remote disablement command or shutdown.

### Active Light Code

In certain additional embodiments, a remote device comprises a detector such as an optical sensor, and a transmitter that transmits an electromagnetic signal, such that the electromagnetic signal transmitted targets at least one robot. Each robot comprises a receiver which, in some embodiments, may be a photodiode, and a “visible response element” which generates an output signal such a laser pulse,

In certain embodiments, when the device transmits a signal each robot within a defined distance, will in response, transmit a series of flashes of light (much like a visible morse code), with different durations or flash rates, such that each robot transmits a unique active light code. The code is read by the optical sensor comprising the remote device and each robot is thereby identifiable. The operator may then select the desired robot as identified by its unique code and subsequently transmit a further command, thereby selectively identifying, commanding, and in some embodiments initiating a remote disablement or shutdown of at least one robot in a group of robots. Further robots of the group may be shut down in a similar manner. In some embodiments the device may be configured to comprise a visible light beam coupled to the electromagnetic signal, such that the electromagnetic beam can be easily visually targeted to the selected robot by the operator. In other embodiments, a series of flashes may represent a robot state, such that a robot may respond to an electromagnetic signal by transmitting a series of flashes that report its current state, such as on, stalled, off-line, soft shutdown or forced shutdown. The emitted light may be emitted from a laser, and comprise a laser pulse or continuous wave, wherein the laser pulse has a predefined flash or pulse rate, or the active light code may be generated by an LED source, or other suitable method.

### IR Cameras

In some embodiments, the device disclosed herein may comprise an electromagnetic camera such as an IR camera. Such cameras may, by virtue of an image analysis chip, identify a number of IR light sources such as signals that are transmitted from the robot, and report their position on the camera CCD or CMOS, and their (approximate) size and brightness. The IR camera may also be used to measure yaw, and accelerometers may also comprise the device such as it can be used to measure pitch and roll, and combining the two sources yields the full orientation of the device such that the remote device may function like a 2D mouse and allow the operator to effectively take aim, visually identify, and target a particular robot that is requiring to be disabled or shut down.

### Redundancy Measures

In further embodiments, a data channel may be used along with, and in addition to any method of identifying, communicating, and controlling a robot by transmitting an electromagnetic signal as disclosed herein. Such data channels are thus encoded in order to provide an additional level of control, such as providing a command protocol to perform a system shutdown or disablement in order to provide system redundancy and diversity. Further, electromagnetic signals may be encoded to provide specific commands that may be decoded and implemented by the robots software and hardware. In some embodiments, the remote device comprises a plurality of channels, each channel capable of emitting one signature encoded IR signal, wherein each signal represents one command. Further, devices may transmit and receive signals that comprise the same or of different mediums.

### Short Range Electromagnetic Signals

In some embodiments, commanding a robot (wherein the robot may be an individual robot, or one of a group of robots) to perform for example, a disablement or shutdown, may require placing a device comprising a short range signal into an area proximal to the robot that requires shutdown. Such a device may comprise a pole, a stick, an extendable object, a drone or another remote controllable device, such that an operator may physically locate a signal in close proximity to a robot, thereby only the robot in proximity to the short range signal will undergo shutdown. The short-range signal may be an electromagnetic signal, such as but not limited to an IR signal, or RF signal, such that the signal may initiate a shutdown protocol, or a signal may trigger a fuse and break a circuit causing the robot to undergo shutdown, wherein the shutdown may be emergent or soft. The range of an electromagnetic signal is tunable or can be modified by changing the frequency, power or wavelength of the signal in order that the signal reaches robots in a defined distance or range. In some embodiments a short-range signal has a range of less than 10 meters, in other embodiments less than 5 meters, and in further embodiments less than 1 meter, wherein the renege is measured from the remote device to the selected robot.

### Flag-Robot

In other embodiments, a robot may comprise a number of flags or the like, located on the robot. Such flags are located in easily accessible positions on the robot, and a robot may have more than one flag. A flag may function to keep a safety circuit open, or in another embodiment may function by keeping a safety circuit closed while the flag is attached. Communication between an operator and a robot is by removal of a flag, which activates or triggers a shutdown protocol, for example by triggering a switch or a fuse to break a circuit and induce a hard or soft shutdown. In some embodiments, an operator may use a device (such as a pole or stick) to access and remove the flag in order to increase the physical distance between a human operator and a robot requiring disablement.

### RFID Devices

In some embodiments, a RFID reader/RFID-tag may be used to communicate a shutdown requirement to a robot. In certain embodiments, an object or device may be configured such that it comprises a RFID tag or a RFID reader. A device may be a projectile, such as but not limited to a ball, wherein the ball may be aimed at, and thrown to make contact with a robot that has been identified as requiring a remote disablement or a shutdown. In some embodiments, the “ball” may function as an RFID reader that transmits an electromagnetic pulse. Once in contact with, or in close proximity to the robot, the emitted signal from the reader activates an unique RFID tag on the robot, which then produces a signal that initiates a shutdown of the robot. In some embodiments the distance between a device and a robot may be described as proximal when the distance is less than 5 meters, between 0.5 meters and 2 meters, and between 2 and 5 meters. In some embodiments, greater than 5 meters is distal to the robot.

In another embodiment the RFID reader may be located on the robot, and the device (such as ball) comprises a RFID tag. The reader located on the robot, emits a signal, and when the ball comprising a RFID tag makes contact with the robot (or is close to the robot), the signal emitted from the reader, activates the tag on the ball, which then broadcasts a shutdown signal directly to the robot that comprises the reader that emitted the original signal. Embodiments may comprise active or passive RFID, and any of low frequency, high frequency, or ultrahigh frequency signals.

### Emergency Activated RF Signal

In some embodiments, an operator may carry a device that comprises a “snap and activate” signal. A device may for example be an emergency glow stick or the like, such that when the operator “snaps” the stick, a circuit is formed by the snapping process, and once the circuit is complete the device communicates with the robot by emitting a RF signal which is recognized by all robots within a defined proximity to the operator. In some embodiments, the emergency glow stick is a remote device that is activated by the “snapping” and completing on the circuit to form an activated remote device. In some embodiments the RF signal communicates an emergency stop, and the robot shuts down or is disabled. In some embodiments the frequency of the RF signal will define the range over which the emergency stop will be effective, and can be tuned by the operator.

### Gesture Recognition

In some embodiments a robot may be controlled by human robot interactions (HRIs), such as, but not limited to: facial expressions, biometric recognition, or hand gestures. In one embodiment, a robot may comprise a hardware system comprising a communication interface and a processor. The communication interface may be configured to receive gesture sensor data from a gesture detection device, wherein the gesture sensor data includes at least one gesture command. The processor may be in communication with the communication interface, and the processor may further be configured to determine a control command for controlling an operation of the robot based on the gesture sensor data, wherein for example the gesture data may initiate a robot task, such as but not limited to a halt, or a shutdown.

In some embodiments, gesture control comprises a transmitter and a receptor, wherein for example the transmitter unit, may comprise a wearable sensor. The transmitter may in some embodiments comprise sensors, such as a gyroscope, and an accelerometer, such that coordinate data from a hand gesture is encoded and transmitted (by for example a bluetooth or wi-fi connection) to the receptor on the robot. The receptor processes the encoded signal, such that the signal imparts on the robot, control of drivers and actuators in order to cause a robot to perform a task, such as to place down a payload, sit down, return to dock or perform a hard shutdown. In some embodiments, 3D geometric representation of a facial expression may be generated, such that a camera or a scanning device on the robot may capture a 3D geometric “faceprint” of an operative entity and compare the digitized “faceprint” to a predetermined library for a data-signal match in order to determine if a condition is met or not met, and thus perform a remote disablement.

Similarly, in other embodiments, a gesture such as a hand signal to indicate stop, or a pointing gesture to indicate moving in a particular direction may be precoded into the robot's system for comparative analysis, such that if a robot “reads and captures” a gesture by virtue of a scanning device or a camera, a gesture may trigger a command protocol such that the robot performs a predetermined task, which may be for example a halt, a soft shutdown or a hard shutdown, such that switch may be triggered in order to blow a fuse and short the robots system. A gesture, by virtue of its 3D coordinates, may be represented as a mathematical algorithm, which are digitized and compared to a predetermined library for a data-signal match in order to determine if a condition is met or not met, and thus perform a remote disablement. In some other embodiments, a method of identifying, communicating with, and commanding a robot, may comprise haptic feedback systems and technologies. In some embodiments for example a remote device is wearable, such as a glove, and or a visor such that wearable elements comprise haptic feedback systems that allow a remote disablement of a robot identified as requiring suchdown.

### Sound Based Communication

In some embodiments, an acoustic signal may be used to communicate with a robot in order to initiate a remote shutdown. By way of example, an acoustic signal may be a directional whistle, wherein the acoustic signal (directional sound wave) when received for example by a microphone located on a robot and processed and correlated such as for example through a data signal match, will initiate a robot shutdown protocol. In some embodiments, a sound wave with a large amplitude (louder sound signal) will be received by and command/communicate all the robots in a group which are located within a specific range (distance) of the operative entity and perform a shutdown; and in another embodiment, a smaller amplitude signal (quieter sound signal) will cause only the robot in direct proximity to the operator to shutdown. In certain embodiments, a code word such as a voice command may be broadcast, such that when the robot receives and processes the signal, it performs a shutdown. In some embodiments for example, the code word or phrase “Digit, stop” will cause the robot to execute a remote shutdown. Other code words, phrases or voice commands given by an operative entity may be used to execute specific shutdown behaviors, such as a hard shutdown, a soft shutdown, a halt, place a payload down, freeze, sit, crouch, collapse, lie down, sit up, stand up, go, return to docking station, or a combination thereof, such that a sequence of maneuvers may be performed in a controlled manner. In some embodiments, voice commands are prefaced by the word “Digit” followed by the specific command, such as “Digit, halt”. In some embodiments, these operative entity issued code words are predefined and do not require an automatic speech recognition proceeding step. In other embodiments, it may be necessary for a non-user, such as a member of the public or a non-operative entity to verbally communicate with the robot and issue a voice command to shutdown the robot. In such embodiments an individual is unlikely to have knowledge of specific code words that would generate a stop, therefore in such embodiments, a microphone unit positioned on the robot captures sound from the surrounding environment and generates corresponding audio signals from the environment (environmental signal), and performs automatic speech recognition on the audio signals. The robot then compares the results from the speech recognition protocol to a library of predefined code words that, upon recognition of the code word, causes the robot to transition from a first state, such as “performing a task” to a second state, such as “shutdown”. Additionally, in some embodiments, the volume at which a code word is spoken may also be measured by the microphone located on the robot in order to provide an additional parameter by which to identify a verbal signal as requesting a hard shutdown or a soft shutdown.

In some embodiments, a group shutdown may be commanded by such a predetermined code word, or an individual robot commanded with a different predetermined code word. In some other embodiments the acoustic signal may be sonar clicks. In some embodiments, high frequency ultrasound waves which comprise short wavelengths and are thereby highly directional may be used to transmit a signal to a robot or from a robot. In some embodiments, an acoustic signal such as an active sonar, or a passive sonar.

In some embodiments, active sonar transducers emit an acoustic signal or pulse of sound into a working environment, if a robot is in the path of the signal, the signal will bounce off the robot and return an “echo” to the sonar transducer. The transducer is equipped with the ability to receive signals, and measures the strength of the signal. By determining the time between the emission of the signal and its reception, the transducer can determine the distance and orientation of the robot. Such methodology may be utilized to give information about the location of a single robot, or the distance between robots, such that transducers are located on each robot.

Passive sonar systems may be used to measure a sound wave or signal emitted from a robot, which may in some embodiments comprise a unique robot ID, however a passive sonar only receives signals, and does not emit signals and may only be used to indicate the location of a robot, through triangulation of an acoustic signal. In further embodiments, a robot may emit or transmit any of the above types of disclosed acoustic signals in response to a received signal, such as but not limited to a “word” or “speech”, which is audible to a human operator.

### Operation Center Control

In some embodiments, a robot, or group of robots may be controlled via a display on a “command screen” in an operations center. In such an embodiment, an operating entity may select the robot to be shutdown, by for example identifying the robot on the command screen and send it a multi-protocol shutdown signal via wired communication components, wireless communication components, cellular communication components, Near Field Communication (NFC) components, Bluetooth® components (e.g., Bluetooth® Low Energy), Wi-Fi® components, RF components. In some further embodiments, a command screen may be displayed on a remote device, such as a cell phone, laptop or tablet, and a robot selected for shutdown in much the same manner. In other embodiments, a robot(s) may be paired to a cell phone and identified and controlled by virtue of selecting a robot icon via a cellular application, wherein a selected robot may be commanded accordingly, such as to perform a shutdown or a disablement.

Any of the methods disclosed herein, may be used in conjunction with any further method or methods disclosed, in order to generate a hierarchical stop system, such that one or more methods of achieving a robot shutdown or disablement are encoded or utilized into one robot system.

Descriptions of additional examples of various embodiments of the present invention are provided below in the form of numbered claims. These claims are not intended to limit the scope of the present invention.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

1-116. (canceled)

117. A method of directing a group of deployed autonomous robots to place themselves in a safe-state, wherein the method comprises:
determining, based on one or more identified conditions, a safety-related action each of the robots in the group should undertake; and
transmitting one or more signals to each of the robots in the group; whereby the one or more signals cause each of the deployed autonomous robots in the group to place themselves in a safe-state.

118. The method of claim 117, wherein the group comprises one or more bipedal robots.

119. The method of claim 117, wherein the one or more signals comprises a signal having a first range, wherein the signal is transmitted by a device, and wherein the device is one of a fleet management system, a warehouse control system, a work cell system, and a remote device.

120. The method of claim 119, wherein the signal is transmitted from a remote device, and wherein the remote device is located within the first range.

121. The method of claim 120, wherein a remotely operated vehicle carries the remote device to a location within the first range.

122. The method of claim 120, wherein the remote device comprises a RFID ball that is moved to a location within the first range.

123. The method of claim 120, wherein the first range of the signal is modifiable.

124. The method of claim 120, wherein the first range of the signal is fixed.

125. The method of claim 120, wherein transmitting the signal comprises activating the remote device by completing a circuit of the remote device.

126. The method of claim 117, wherein one or more of the identified conditions comprise: requiring maintenance, requiring charging, requiring relocating from a first location to a second location, requiring shutdown, requiring switching task, and requiring activation.

127. The method of claim 117, wherein the safety-related action is one of a category one shutdown and a category zero shutdown.

128. The method of claim 117, wherein the step of transmitting one or more signals comprises: scanning an object to obtain an object representation by the group of robots; and interpreting, by the group of robots, that the object representation correlates to a command to move to a safe-state.

129. The method of claim 117, wherein the step of transmitting one or more signals comprises: generating an acoustic signal; receiving the signal at the group of robots; and correlating, by the group of robots, the acoustic signal to a command to move to a safe-state.

130. The method of claim 129, wherein the acoustic signal is one or more of a voice command and a whistle.

131. The method of claim 117, wherein the step of transmitting one or more signals comprises: configuring the deployed autonomous robot to move to a safe-state when a safety circuit is opened; and opening the safety circuit on the robot.

132. The method of claim 131, wherein the step of opening a safety circuit on the robot comprises removing a flag from the deployed autonomous robot.

133. The method of claim 117, further comprising: executing, by each of the deployed autonomous robots in the group, a hierarchical command protocol after receiving the one or more signals, wherein each of the robots in the group initiates a self evaluation protocol, wherein if a predefined condition value is met, the robot initiates a soft shutdown, and the hierarchical protocol places the group of robots in a safe-state.

134. A computing system operably associated with a group of robots, the computing system comprising:
data processing hardware; and memory hardware in communication with the data processing hardware, wherein the memory hardware stores instructions that when executed on the data processing hardware cause the data processing hardware to perform operations comprising claim 1.

135. The method of claim 117, wherein a safe state comprises a robot that is: powered down, in a safe limited position, or in a stand-by mode.

136. A method of directing a group of one or more deployed bipedal robots to perform a remote shutdown in response to an identified safety related condition, wherein the method comprises:
determining, that each robot in the group requires a safety related shutdown, wherein the safety-related shutdown is one of a category one shutdown and a category zero shutdown;
transmitting at a processor, one or more signals to each of the robots in the group, wherein the one or more signals comprise a signal having a range which is one of modifiable and fixed; and
executing, by each of the robots in the group, a hierarchical command protocol after receiving the one or more signals, wherein each of the robots in the group initiates a self evaluation protocol, wherein if a predefined condition value is met the robot initiates a category one shutdown and the hierarchical command protocol places each of the robots in the group in a safe-state and wherein each robot is powered down, and if the predefined condition value is not met the robot initiates a category zero shutdown, and power to its motors are immediately cut.
